(19) United States
(12) Patent Application Publication
(10) Pub. No.: US 2007/0253603 A1
(43) Pub. Date: Nov. 1, 2007

(54) Monitoring device, method and program thereof

(75) Inventors: Masataka Kimura, Ichinomiya-shi (JP); Takamitsu Ishikawa, Ichinomiya-shi (JP); Takeshi Kakinuma, Kaizu-shi (JP); Ryosuke Kono, Ichinomiya-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto-shi (JP)

(21) Appl. No.: 11/789,086

(22) Filed: Apr. 23, 2007

(30) Foreign Application Priority Data
Apr. 28, 2006 (JP) 2006-126364

(51) Int. Cl. G06K 9/00

(52) U.S. Cl. 382/115

(57) ABSTRACT

A camera that picks up images for the purpose of extracting facial images can be adjusted on the basis of images.

The facial image extraction section extracts a facial image of a checking target person from an image that is picked up by the entrance camera and the facial detection judgment section judges whether a facial image can be extracted, by the facial image extraction section, from the image under predetermined conditions. In cases where, in accordance with the judgment result, a facial image cannot be extracted, by the processing of the facial image extraction section, from the image under predetermined conditions, the camera control section controls the image pickup state of the entrance camera. The present invention can be applied to a monitoring system.

### BACKGROUND OF THE INVENTION

1. Field of the Invention

The present invention relates to a monitoring device and monitoring method and to a program thereof and, in particular, to a monitoring device and method and program for the accurate implementation of processing of a customer's facial image.

2. Description of the Related Art

Technology that photographs and automatically identifies the face of a customer entering the store has generally become widespread.

For example, technology which involves using a camera installed in the store to photograph the face of a customer entering via the entrance to the store, performing a check by comparing pre-registered facial image information with the facial image picked up, and then judging whether the customer entering the store is a particular person has been proposed (See Japanese Application Laid Open No. 2002-279540).

However, in the case of the above technique, as per a technology that is used by general facial recognition devices used for entrance and departure, because the checking target person is unaware that an image of his own face is being picked up unlike active image pickup processing where the checking target person consciously wishes to be recognized, because it cannot be said that the direction of the camera used for image pickup is oriented, facial image pickup from the front, which is readily used in recognition processing, is sometimes not possible.

Because, as a particular tendency in the way people move, people have a tendency to direct their eyes toward the thing or phenomenon interested in them, people naturally turn their face in the direction in which the thing or phenomenon interested in them is produced. Hence, even though a camera is installed in the entrance to the store with the intention of picking up an image of the face of the customer arriving at the store and acquiring a facial image, the feature of the face cannot be extracted depending on the particular direction of the face and the face can sometimes not be extracted as a facial image. In a gaming facility in particular, because the preferences of the player also change depending on whether gaming facilities are exchanged for new gaming machine and other such events, the direction of the player's face sometimes changes depending on the day and time and there is a probability that a facial image which is suited to recognition processing will not be obtained.

Therefore, in order to adapt to such a situation, even in a state where the face is oriented in a particular direction with respect to one image pickup point, a plurality of cameras must be installed while estimating the direction in which the face appears to be oriented in order to be able to extract facial images with a quality level that can be used in recognition processing. Hence, not only have the costs of mounting the cameras on equipment been high but, when the image pickup range is determined, it has also sometimes been necessary to make zoom and iris adjustments or other adjustments for the individual cameras, which has been labor-intensive.

In addition, irrespective of the adjustments to establish the optimum range when the cameras are installed, because the focus is sometimes displaced due to the irregularity of adjustment on account of vibrations and shocks with respect to the lens and dirt or dust on the lens, in cases where a large number of cameras are installed, re-adjustment is sometimes also required for each camera, which is labor-intensive.

### SUMMARY OF THE INVENTION

The present invention was conceived in view of such a situation and was constituted so that the camera used in the facial recognition processing can be adjusted in real-time to an optimum state for the image pickup of a facial image.

The monitoring device of a first aspect of the present invention comprises accumulation means for accumulating facial images of registered people that have been pre-registered; image pickup means for picking up an image; facial image extraction means for extracting a facial image of a checking target person from the image picked up by the image pickup means; judgment means for judging whether the facial image has been acquired under predetermined conditions from the image by the facial image extraction means; control means for controlling the image pickup state of the image pickup means when the facial image has not been acquired under predetermined conditions from the image by the facial image extraction means according to the judgment result of the judgment means; checking means for calculating and checking the similarity between the facial image of a checking target person extracted by the facial image extraction means and the facial images of the registered people that have accumulated in the accumulation means; similarity judgment means for judging whether the facial image of the checking target person is the facial image of a registered person through a comparison between the similarity, which is the checking result of the checking means, and a predetermined threshold value; and communication means for communicating the fact that the checking target person is the registered person when it is judged by the similarity judgment means that the checking target person is the registered person.

The monitoring device can further comprise facial feature extraction means for extracting facial feature from the facial image of the checking target person so that the checking means is able to calculate similarity by using the facial feature of the facial image of the checking target person that has been acquired by the acquisition means and facial images of registered people that have accumulated in the accumulation means and check the facial image of the checking target person acquired by the acquisition means against the facial images of the registered people that have accumulated in the accumulation means.

The monitoring device can further comprise unregistered person registration means for registering a facial image of the checking target person as an unregistered person when it is judged by the similarity judgment means that the checking target person is not the registered person.

The accumulation means is able to accumulate facial images of registered people that have been pre-registered in the form of a database; and facial images of unregistered people that have been registered a predetermined number of times or more by the unregistered person registration means can be registered in the database as the facial images of the registered people.

The control means can comprise focus control means for controlling the focal position of the image pickup means; pan-tilt-zoom control means for controlling at least any of the pan, tilt, and zoom positions of the image pickup means; and iris control means for controlling the iris of the image pickup means, so that, in cases where, in accordance with the judgment result of the judgment means, a facial image cannot be extracted from the image by the facial image extraction means, the focus control means is able to control the focal position of the image pickup means and the pan-tilt-zoom control means is able to adjust the image pickup state of the image pickup means by controlling at least any of the pan, tilt, and zoom positions of the image pickup means; and so that, in cases where, in accordance with the judgment result of the judgment means, a facial image has been extracted from the image by the facial image extraction means and the difference in brightness of the facial image from that of a predetermined facial image is larger than a predetermined threshold value, the iris control means is able to adjust the image pickup state of the image pickup means by controlling the iris of the image pickup means.

In cases where a facial image cannot be extracted from the image by the facial image extraction means, the focus control means is able to control the focal position of the image pickup means and the pan-tilt-zoom control means is able to adjust the image pickup state of the image pickup means so that the focal point is moved further away in steps at predetermined distance intervals by controlling at least any of the pan, tilt, and zoom positions of the image pickup means.

The monitoring device can further comprise recording means for recording an image that is picked up by the image pickup means, wherein defective detection information can be generated on the basis of the images recorded by the recording means, in cases where a facial image cannot be extracted from the image by the facial image extraction means in a state where the image pickup state of the image pickup means is adjusted by moving the focal position a predetermined distance away as a result of the focus control means controlling the focal position of the image pickup means and the pan-tilt-zoom control means controlling at least any of the pan, tilt, and zoom positions of the image pickup means.

The monitoring device can further comprise passage sensing means for sensing the passage of the checking target person so that the judgment means is able to judge whether a facial image can be acquired under predetermined conditions from the image by the facial image extraction means through a comparison between the ratio of the frequency of extraction of a facial image from the image by the facial image extraction means with respect to the sensing frequency of the passage sensing means, and a predetermined value and, when the ratio is smaller than the predetermined value, the judgment means is able to judge that a facial image cannot be acquired from the image by the facial image extraction means under predetermined conditions.

A monitoring method of the first aspect of the present invention is a monitoring method comprising: an accumulation step of accumulating facial images of registered people that have been pre-registered; an image pickup step of picking up images; a facial image extraction step of extracting the facial image of a checking target person from the image picked up by the processing of the image pickup step; a judgment step of judging whether a facial image can be extracted under predetermined conditions from the image by the processing of the facial image extraction step; a control step of controlling the image pickup state of the processing of the image pickup step in cases where a facial image cannot be extracted under predetermined conditions from the image by the processing of the facial image extraction step in accordance with the judgment result of the processing of the judgment step; a checking step of calculating and checking the similarity between the facial image of the checking target person extracted by the processing of the facial image extraction step and the facial images of the registered people that have accumulated in the accumulation step; a similarity judgment step of judging whether the facial image of the checking target person is the facial image of a registered person through a comparison between the similarity which is the checking result of the processing of the checking step and a predetermined threshold value; and a communication step of communicating the fact that the checking target person is the registered person in cases where it has been judged, by the processing of the similarity judgment step, that the checking target person is the registered person.

A program of the first aspect of the present invention is a program that causes a computer to execute processing, comprising: an accumulation step of accumulating facial images of registered people that have been pre-registered; an image pickup step of picking up an image; a facial image extraction step of extracting a facial image of a checking target person from the image that has been picked up by the processing of the image pickup step; a judgment step of judging whether the facial image has been extracted under predetermined conditions from the image by the processing of the facial image extraction step; a control step of controlling the image pickup state of the processing of the image pickup step when the facial image has not been extracted under predetermined conditions from the image by the processing of the facial image extraction step according to the judgment result of the processing of the judgment step; a checking step of calculating and checking the similarity between the facial image of a checking target person extracted by the processing of the facial image extraction step and the facial images of the registered people that have accumulated in the accumulation step; a similarity judgment step of judging whether the facial image of the checking target person is the facial image of a registered person through a comparison between the similarity, which is the checking result of the checking step, and a predetermined threshold value; and a communication step of communicating the fact that the checking target person is the registered person when it is judged by the processing of the similarity judgment step that the checking target person is the registered person. In the monitoring device, method, and program of the first aspect of the present invention, facial images of registered people that have been pre-registered are accumulated, images are picked up, the facial image of the checking target person is extracted from the picked up image, it is judged whether a facial image can be extracted under predetermined conditions from the image and, in cases where, in accordance with the judgment result, a facial image cannot be extracted under predetermined conditions from the image, the image pickup state is controlled, the similarity between the extracted facial image of the checking target person and the facial images of the accumulated registered people is calculated and checked; it is judged, through a comparison between the similarity which is the checking result and a predetermined threshold value, whether the facial image of the checking target person is the facial image of a registered person and, when the checking target person is the registered person, the fact that the checking target person is the registered person is communicated.

The accumulation means for accumulating facial images of registered people that have been pre-registered, of the monitoring device of the first aspect of the present invention is a registered player database; the image pickup means for picking up an image is an entrance camera; the facial image extraction means for extracting the facial image of the checking target person from the image picked up by the image pickup means is, for example, a facial image extraction section; the judgment means for judging whether a facial image has been extracted under predetermined conditions from the image by the facial image extraction means is a facial detection judgment section; the control means for controlling the image pickup state of the image pickup means in cases where, in accordance with the judgment result of the judgment means, a facial image cannot be extracted under predetermined conditions from the image by the facial image extraction means is a camera control section; checking means for calculating and checking the similarity between the facial image of a checking target person extracted by the facial image extraction means and the facial images of the registered people that have accumulated in the accumulation means; similarity judgment means for judging whether the facial image of the checking target person is the facial image of a registered person through a comparison between the similarity, which is the checking result of the checking means which is a checking section, for example, and a predetermined threshold value is a similarity judgment section, for example; and communication means for communicating the fact that the checking target person is the registered person when it is judged by the similarity judgment means that the checking target person is the registered person is, for example, a communication section.

In other words, the entrance camera picks up images and the image pickup acquisition section extracts a facial image of the checking target person from the image picked up by the entrance camera; the facial detection judgment section judges whether a facial image can be extracted from the image under predetermined conditions and, in cases where, in accordance with the judgment result of the facial detection judgment section, a facial image cannot be extracted from the image by the facial image extraction section under predetermined conditions, the camera control section controls the image pickup state of the entrance camera.

Consequently, in order to establish a state where a facial image can be acquired from the image picked up by the entrance camera, it is possible to set the entrance camera so that the optimum image can be picked up in order to extract a facial image by controlling the pan, tilt, and zoom, the iris, and the focus of the entrance camera. A facial image can be easily extracted without increasing the number of cameras at the image pickup point; adjustment of the individual cameras can be easily implemented; and facial-image recognition processing can be more accurately implemented.

According to the present invention, a facial image can be easily extracted without increasing the number of cameras at the image pickup point. Adjustment of the individual cameras can be easily implemented. Facial-image recognition processing can be more accurately implemented.

### BRIEF DESCRIPTION OF THE DRAWINGS

FIG. 1 shows the constitution of a first embodiment of the monitoring system to which the present invention is applied;

FIG. 2 shows an example of the installation of the camera in FIG. 1;

FIG. 3 shows an example of the installation of the camera in FIG. 1;

FIG. 4 shows an example of the installation of the camera in FIG. 1;

FIG. 5 shows an example of the installation of the camera in FIG. 1;

FIG. 6 shows an example of the installation of the camera in FIG. 1;

FIG. 7 shows an example of the installation of the camera in FIG. 1;

FIG. 8 shows an example of the installation of the entrance camera, in-store camera, and entrance dual sensor in FIG. 1;

FIG. 9 illustrates a constitutional example of the image processing unit in FIG. 1;

FIG. 10 illustrates a constitutional example of the entrance image processing unit in FIG. 1;

FIG. 11 illustrates a constitutional example of the biological information recognition device in FIG. 1;

FIG. 12 illustrates a constitutional example of the biological information management sensor and biological information management DB in FIG. 1;

FIG. 13 illustrates a constitutional example of the portable terminal in FIG. 1;

FIG. 14 is a flowchart illustrating processing for monitoring the arrival at the facility of a registered player;

FIG. 15 illustrates an example of the display of a report image;

FIG. 16 is a flowchart illustrating registered player DB update processing;

FIG. 17 is a flowchart illustrating entrance camera adjustment processing;

FIG. 18 is a flowchart illustrating face detection processing;

FIG. 19 illustrates face detection processing;

FIG. 20 illustrates face detection processing;

FIG. 21 illustrates entrance camera adjustment processing;

FIG. 22 illustrates entrance camera adjustment processing;

FIG. 23 illustrates entrance camera adjustment processing;

FIG. 24 is a flowchart illustrating defective detection information display processing;

FIG. 25 illustrates defective detection information display processing; and

FIG. 26 illustrates apparatus.

### DESCRIPTION OF THE PREFERRED EMBODIMENTS

An embodiment of the present invention will be described hereinbelow. However, the relationship between the constitutional requirements of the present invention and the embodiments appearing in the detailed description of the present invention is exemplified as follows. This serves to confirm that embodiments supporting the present invention appear in the detailed description of the invention. Hence, although such embodiments conforming to the constitutional requirements of the present invention appear in the detailed description of the present invention, this does not mean that the absence of embodiments indicates the non-conformity of these embodiments to the constitutional requirements. Conversely, even though embodiments appear here as embodiments that conform to the constitutional requirements, this does not means that the embodiments do not conform to constitutional requirements other than these constitutional requirements.

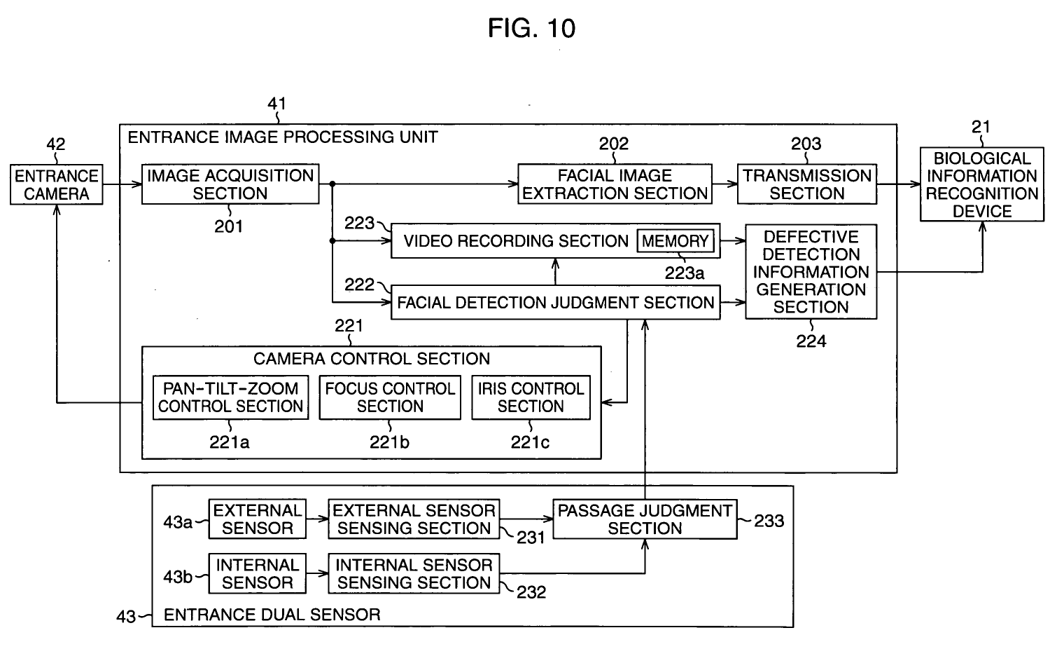

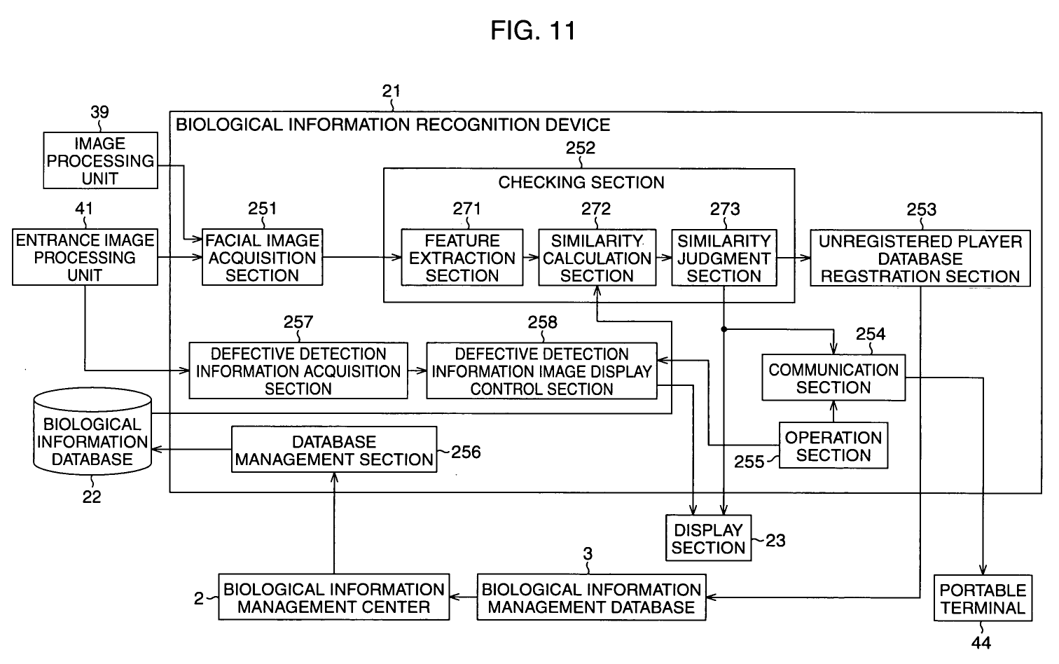

In other words, the monitoring device according to the first aspect of the present invention comprises accumulation means (the biological information database 22 in FIG. 11, for example) for accumulating facial images of registered people that have been pre-registered, image pickup means for picking up an image (the entrance camera 42 in FIG. 10, for example); facial image extraction means for extracting a facial image of a checking target person from the image that was picked up by the image pickup means (the facial image extraction section 202 in FIG. 10, for example); judgment means for judging whether the facial image was acquired under predetermined conditions from the image by means of the facial image extraction means (the facial detection judgment section 222 in FIG. 10, for example); control means for controlling the image pickup state of the image pickup means when the facial image cannot be extracted under predetermined conditions from the image by the processing of the facial image extraction means according to the judgment result of the judgment means (the camera control section 221 in FIG. 10, for example); checking means for calculating and checking the similarity between the facial image of a checking target person extracted by the facial image extraction means and the facial images of the registered people that have accumulated in the accumulation means (the similarity calculation section 272 in FIG. 11, for example); similarity judgment means for judging whether the facial image of the checking target person is the facial image of a registered person by means of a comparison between the similarity, which is the checking result of the checking means, and a predetermined threshold value (the similarity judgment section 273 in FIG. 11, for example); and communication means for communicating the fact that the checking target person is the registered person when it is judged by the similarity judgment means that the checking target person is the registered person (the communication section 254 in FIG. 11, for example).

The monitoring device can further comprise feature extraction means for extracting feature from the facial image of the checking target person (the facial feature extraction section 271 in FIG. 11, for example) so that the checking means (the similarity calculation section 272 in FIG. 11, for example) is able to calculate similarity by using the feature of the facial image of the checking target person that was extracted by the facial image extraction means (the facial image extraction section 202 in FIG. 10, for example), and facial images of registered people that have accumulated in the accumulation means and check the facial image of the checking target person acquired by the acquisition means against the facial images of the registered people that have accumulated in the accumulation means.

The monitoring device can further comprise unregistered person registration means for registering a facial image of the checking target person as an unregistered person when it is judged by the similarity judgment means that the checking target person is not the registered person (the unregistered player database registration section 253 in FIG. 11, for example).

The control means can comprise focus control means for controlling the focal position of the image pickup means (the focus control section 221b in FIG. 10, for example); pan-tilt-zoom control means for controlling at least any of the pan, tilt, and zoom positions of the image pickup means (the pan-tilt-zoom control section 221a in FIG. 10, for example); and iris control means for controlling the iris of the image pickup means (the iris control section 221c in FIG. 10, for example), so that, in cases where, in accordance with the judgment result of the judgment means, a facial image cannot be extracted from the image by the facial image extraction means, the focus control means is able to control the focal position of the image pickup means and the pan-tilt-zoom control means is able to adjust the image pickup state of the image pickup means by controlling at least any of the pan, tilt, and zoom positions of the image pickup means; and so that, in cases where, in accordance with the judgment result of the judgment means, a facial image has been extracted from the image by the facial image extraction means and the difference in brightness of the facial image from that of a predetermined facial image is larger than a predetermined threshold value, the iris control means is able to adjust the image pickup state of the image pickup means by controlling the iris of the image pickup means.

The monitoring device can further comprise recording means for recording an image that is picked up by the image pickup means (the recording section 223 in FIG. 10, for example), wherein, in cases where a facial image cannot be extracted from the image by the facial image extraction means in a state where the image pickup state of the image pickup means is adjusted by moving the focal position a predetermined distance away as a result of the focus control means controlling the focal position of the image pickup means and the pan-tilt-zoom control means controlling at least any of the pan, tilt, and zoom positions of the image pickup means, defective detection information can be generated on the basis of the images recorded by the recording means.

The monitoring device can further comprise passage sensing means for sensing the passage of the checking target person (the entrance dual sensor 43 in FIG. 10, for example) so that the judgment means is able to judge whether a facial image can be extracted under predetermined conditions from the image by the facial image extraction means by means of a comparison between the ratio of the frequency of extraction of a facial image from the image by the facial image extraction means with respect to the sensing frequency of the passage sensing means, and a predetermined value and, when the ratio is smaller than the predetermined value, the judgment means is able to judge that a facial image cannot be acquired from the image by the facial image extraction means under predetermined conditions.

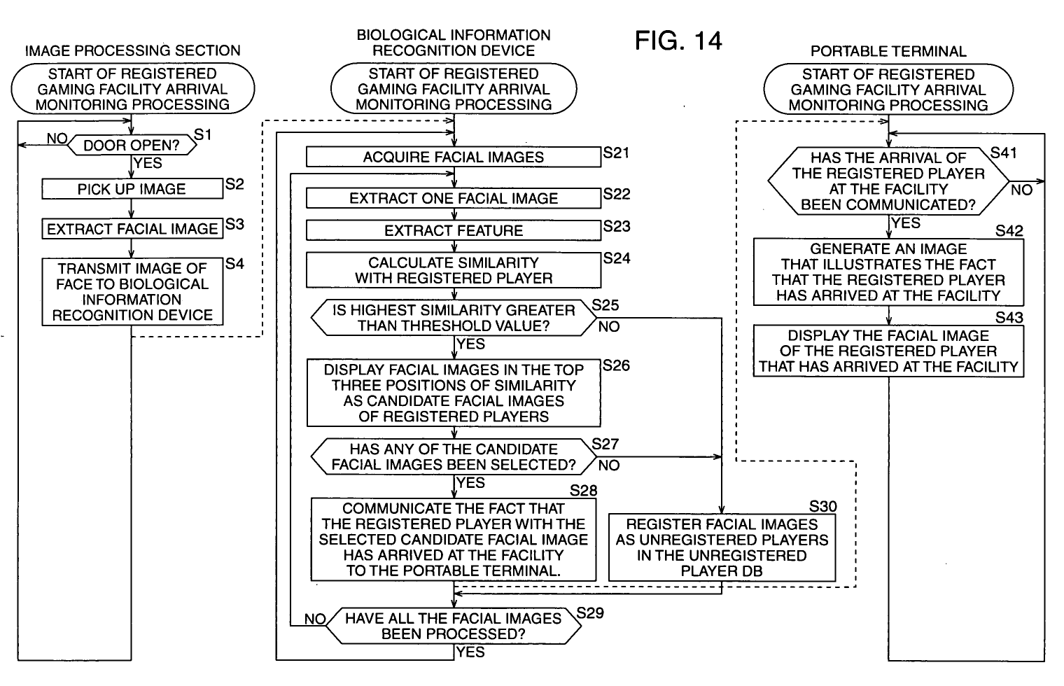

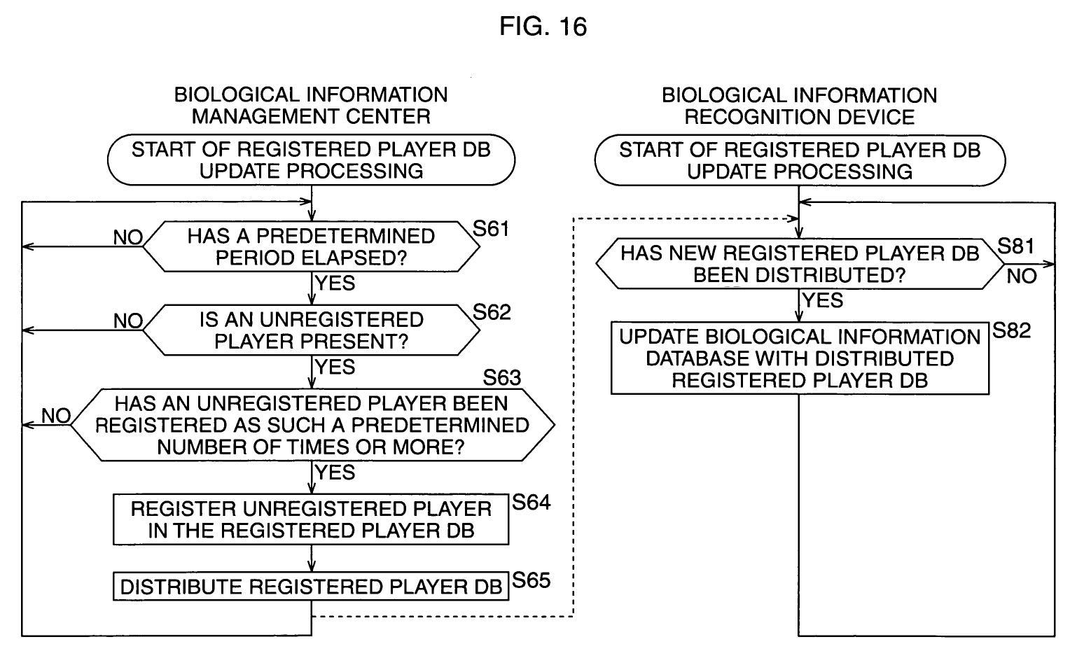

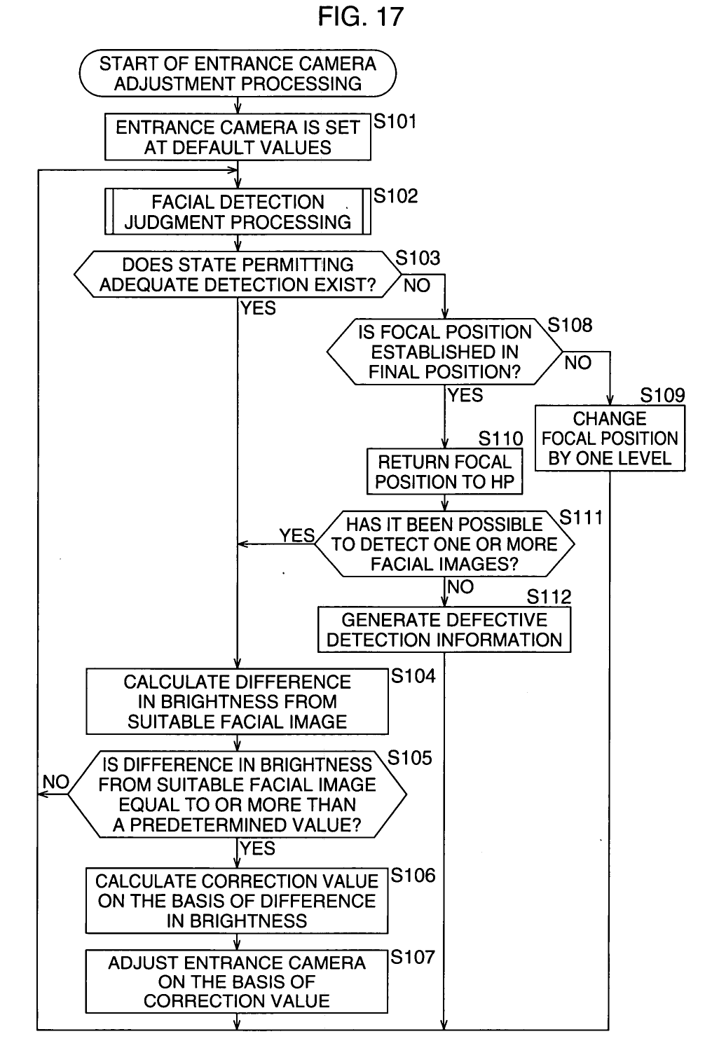

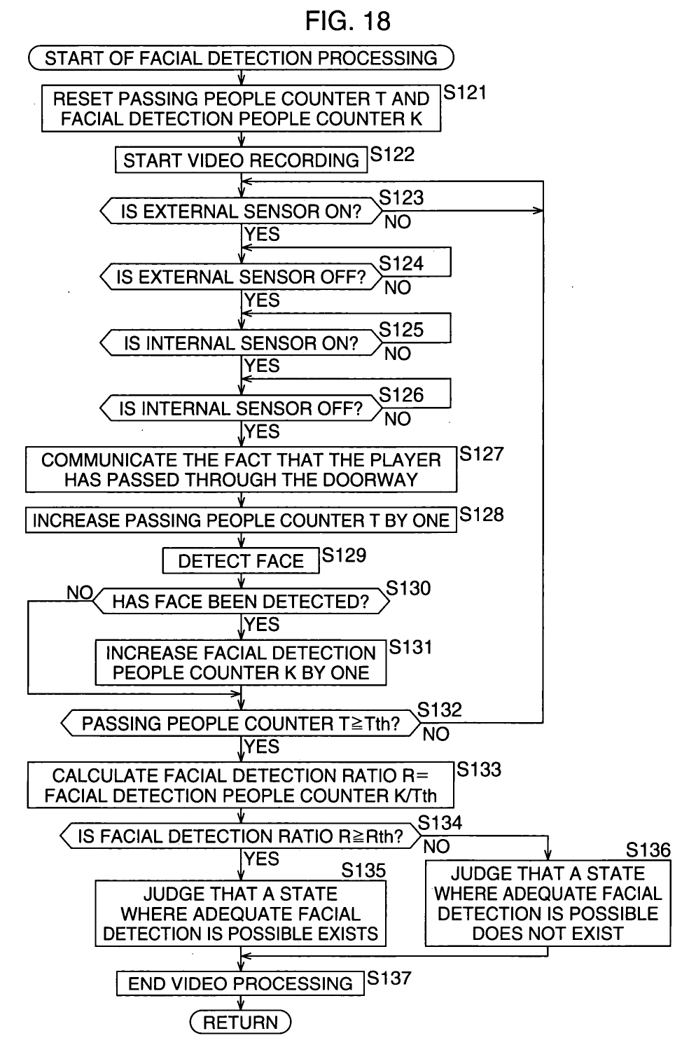

The monitoring method and program of the first aspect of the present invention comprise: an accumulation step of accumulating facial images of registered people that have been pre-registered (step S82 in FIG. 16, for example); an image pickup step of picking up images (step S122 in FIG. 18, for example); an extraction step of extracting the facial image of the checking target person from the image picked up by the processing of the image pickup step (step S129 in FIG. 18, for example); a judgment step of judging whether a facial image can be extracted under predetermined conditions from the image by means of the processing of the facial image extraction step (step S133 in FIG. 18, for example); a control step of controlling the image pickup state of the processing of the image pickup step in cases where a facial image cannot be extracted under predetermined conditions from the image by the processing of the facial image extraction step in accordance with the judgment result of the processing of the judgment step (steps S109 and S107 in FIG. 17, for example); a checking step of calculating and checking the similarity between the facial image of the checking target person extracted by the processing of the facial image extraction step and the facial images of the registered people that have accumulated in the accumulation means (step S24 in FIG. 14, for example); a similarity judgment step of judging whether the facial image of the checking target person is the facial image of a registered person by means of a comparison between the similarity which is the checking result of the processing of the checking step and a predetermined threshold value (step S25 in FIG. 14, for example); and a communication step of communicating the fact that the checking target person is the registered person in cases where it has been judged, by the processing of the similarity judgment step, that the checking target person is the registered person (step S28 in FIG. 14, for example).

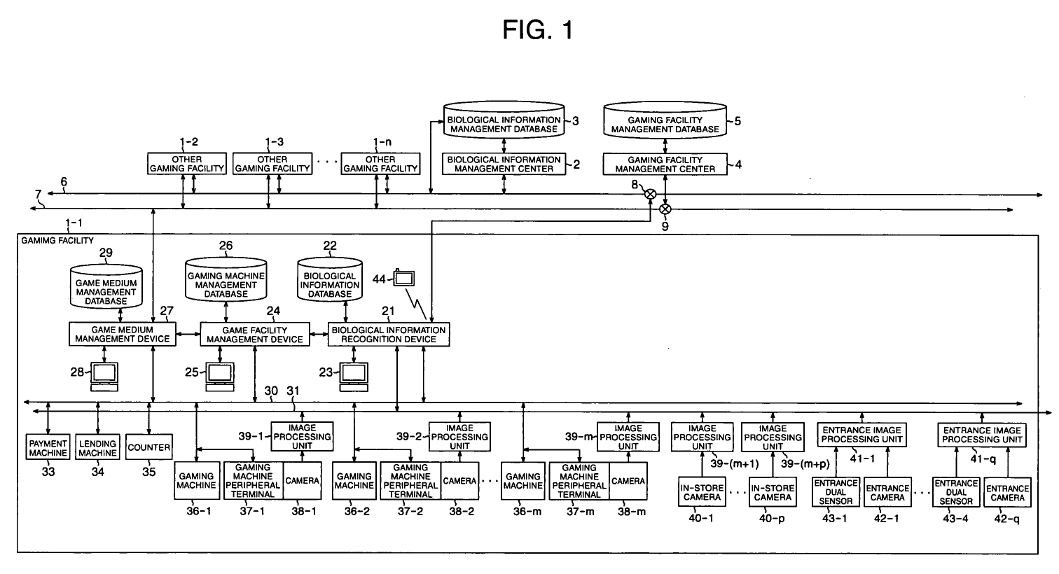

FIG. 1 shows the constitution of a first embodiment of the monitoring system of a gaming facility according to the present invention.

Gaming facilities 1-1 to 1-n are so-called “pachinko parlors” or “pachi-slot parlors.” Further, gaming facilities 1-1 to 1-n are chain facilities or participating facilities of a biological information management center or gaming facility management center and are facilities requiring centralized management of a plurality of facilities. The respective gaming facilities 1-1 to 1-n are connected by a biological information management bus 6 and a gaming facility management bus 7 and exchange biological information and gaming facility management information with one another via public communication networks 8 and 9 representative of the bus and the Internet and so forth. Hereinafter, when there is no need for a particular distinction between the gaming facilities 1-1 to 1-n, these gaming facilities may be simply called the gaming facilities 1 and a similar name is possible for other constitutions.

The biological information management bus 6 mainly functions as a transmission path for distributing biological information that is managed by a biological information recognition device 21 of the respective gaming facilities 1. Further, the gaming facility management bus 7 mainly functions as a transmission path for distributing management information of gaming medium that is managed by game medium management device 27 of the respective gaming facilities 1.

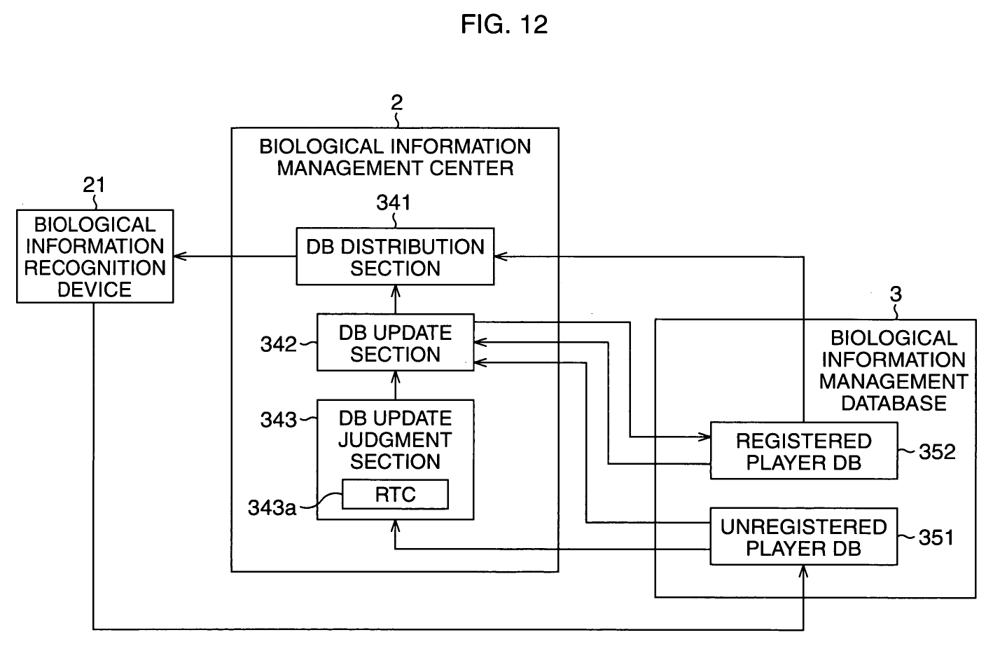

The biological information management center 2 is a server that is used by a business person that manages a biological information management center. The biological information management center 2 updates a registered player DB 352 (FIG. 12) that is managed by the biological information management database (also referred to as ‘DB’ hereinbelow) 3 on the basis of an unregistered player DB 351 (FIG. 12) that is generated by the respective gaming facilities 1, and distributes the latest updated registered player DB 352 to the biological information recognition device 21 of the respective gaming facilities 1.

The gaming facility management center 4 is a server that is used by a business person that manages a gaming facility management center. The gaming facility management center 4 updates the DB that comprises management information of game medium that is managed by the gaming facility management database (DB) 5 on the basis of information that is supplied by the respective gaming facilities 1 and distributes the updated latest management information of game medium to the media lending device management device 27 of the respective gaming facilities 1.

The biological information recognition device 21 performs a check with facial images that have been pre-registered in the biological information database 22 on the basis of information of facial images that is extracted by image processing units 39-1 to 39-(m+p) or entrance image processing units 41-1 to 41-q from images that have been picked up by cameras 38-1 to 38-m or in-store cameras 40-1 to 40-p, and entrance cameras 42-1 to 42-q, the extracted facial image information being supplied via a biological information bus 31 and, in the case of a match, communicates the arrival at the facility of a registered player to the portable terminal 44 and displays the registered player on a display section 23 that comprises a CRT (Cathode Ray Tube) or LCD (Liquid Crystal Display) or the like. Furthermore, the biological information recognition device 21 performs a check with facial images that have been pre-registered in the biological information database 22 and, when there is no match, the biological information recognition device 21 accesses the biological information management database 3 and registers the player in the unregistered player DB 351 as an unregistered player.

A gaming facility management device 24 is called a so-called hall computer. The operation of gaming machines 36-1 to 36-m is monitored via a gaming facility management information bus 30. The gaming facility management device 24 executes predetermined processing in accordance with information on the payout of pachinko balls or medals by the gaming machines 36, call information for the players of the respective gaming machines 36-1 to 36-m, or monitoring states such as the occurrence of an error, and displays the execution results on a display section 25 comprising a CRT or LCD. The game facility management device 24 associates information that is supplied by each of a payment machine 33, a lending machine 34, a counter 35, gaming machines 36-1 to 36-m, and gaming machine peripheral terminals 37-1 to 37-m with identification information identifying each of the aforementioned devices (gaming machine numbers, for example) and manages these associations by means of a gaming machine management database 26.

The game medium device management device 27 uses a game medium management database 29 to manage the game medium management information on the game medium that are lent out on the basis of information from the payment machine 33, lending machine 34, and counter 35 and, when the game medium management information registered in the game medium management database 29 is updated, the game medium device management device 27 sends the updated information to the gaming facility management center 4 via the gaming facility management bus 7 and public communication network 9. In addition, the game medium device management device 27 acquires game medium management information that is supplied by the gaming facility management center 4 via the gaming facility management bus 7 and public communication network 9 and facilities this game medium management information in the game medium management database 29.

Upon acceptance of a predetermined amount of money in the form of cash or a pre-paid card or the like when a player plays a game at a gaming machine 36, the lending machine 34 lends game medium in the quantity corresponding to the amount of money. Thereupon, the lending machine 34 supplies information such as information on the amount of money or number of units remaining of the accepted amount of money or pre-paid card and information on the number of game medium lent out to the game medium device management device 27. As a result, the game medium device management device 27 registers information such as the amount of money or number of units remaining of the accepted amount of money or pre-paid card and information on the number of lent game medium in the game medium management database 29.

The payment machine 33 pays a pre-paid card by adding the frequency for the number of balls borrowed. Thereupon, the payment machine 33 supplies information to the game medium device management device 27 on the frequency of the pre-paid card sold and the amount of money paid. Further, the payment machine 33 counts the cash and pays out money on the basis of remaining number of game medium lent out as the frequency of the pre-paid card or the like. Thereupon, the payment machine 33 supplies the number remaining on the pre-paid card and the amount of cash paid pack to the game medium device management device 27.

The counter 35 counts the number of game medium acquired as a result of the player using a gaming machine 36 to play a game and outputs the result of the count as a magnetic card or receipt.

The gaming machines 36-1 to 36-m execute a game as a result of a predetermined operation being performed by the player and pays out game balls or medals in accordance with a so-called ‘small strike’ or ‘large strike’ (winnings).

The gaming machine peripheral terminals 37-1 to 37-m are so-called inter-station devices that are provided in correspondence with the respective gaming machines 36-1 to 36-m; inter-station ball lending machines (fundamentally similar to the lending machines 34) or the like are provided. Furthermore, the gaming machine peripheral terminal 37 acquires biological information such as facial images of players that play on the gaming machine 36 and transmits the biological information to the gaming machine management device 24 together with game station identification information (gaming machine numbers). Further, FIG. 1 shows an example in which cameras 38-1 to 38-m that acquire facial images of the player are provided as a function for acquiring biological information.

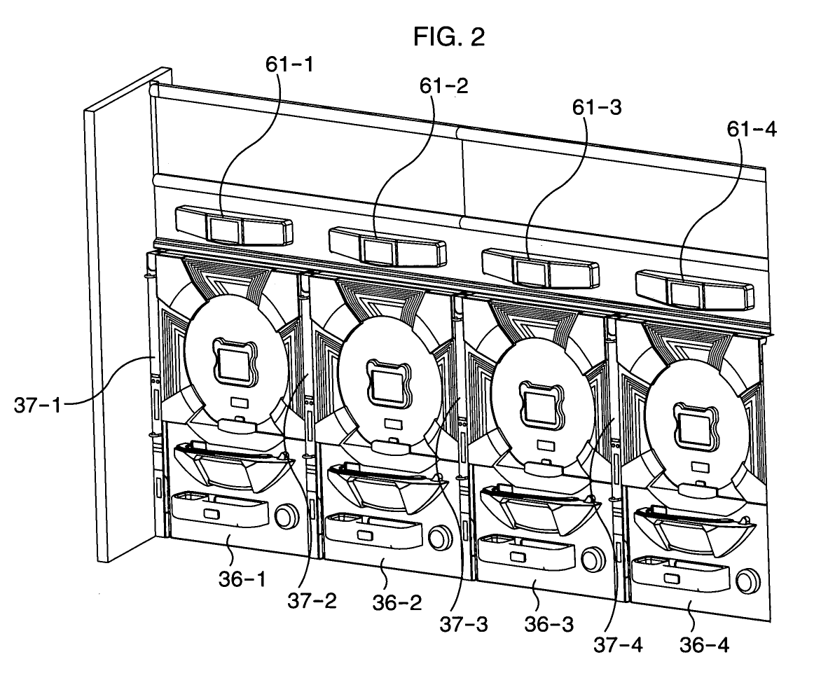

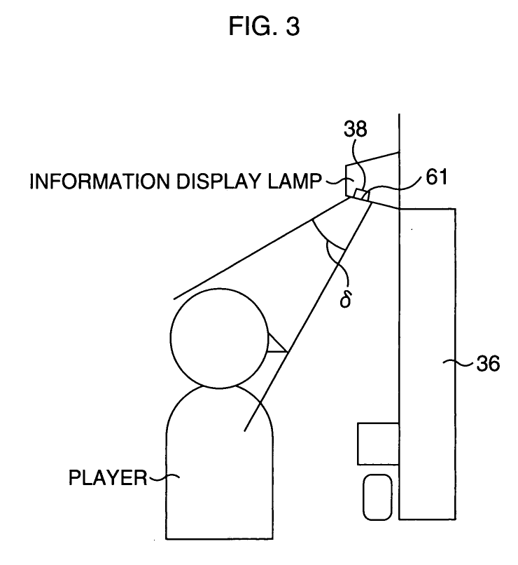

The cameras 38-1 to 38-m may be provided below the information display lamps 61-1 to 61-4 that are installed at the top of the respective gaming machines 36-1 to 36-4 as shown in FIG. 2, for example, so that these cameras 38-1 to 38-m are capable of picking up an image of the player within a reading range δ as shown in FIG. 3 and so that a facial image is picked up. As a result, the respective cameras IDs can be used as gaming machine IDs at the same time.

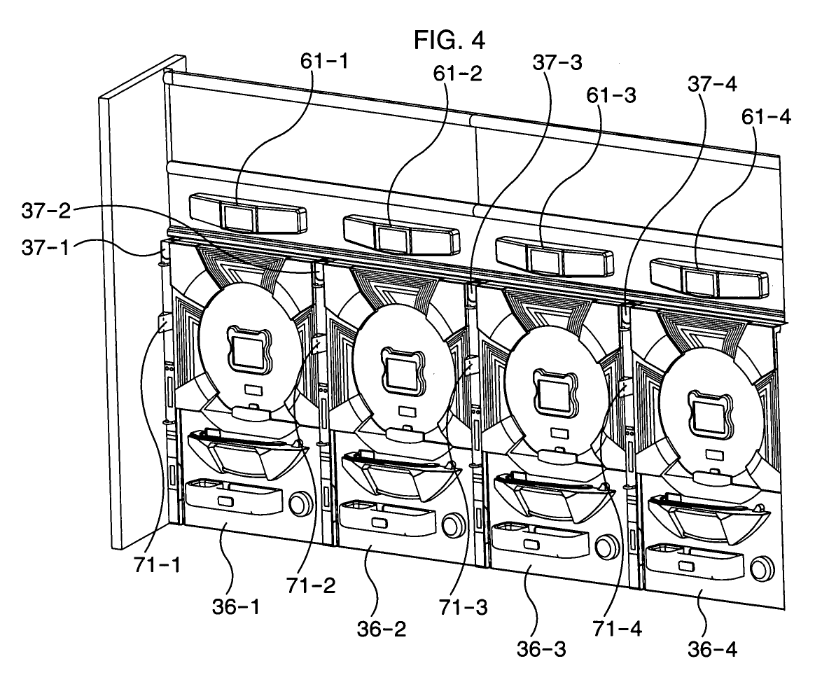

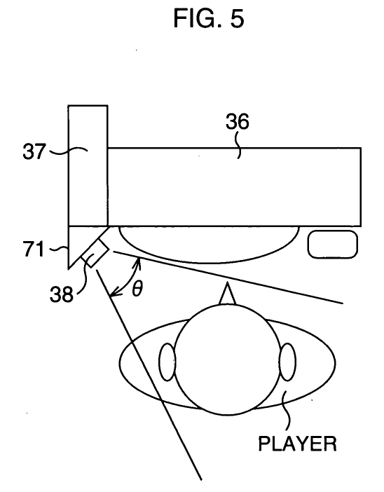

Furthermore, protrusions 71-1 to 71-4 may be provided on the gaming machine peripheral terminals 37-1 to 37-4 as shown in FIG. 4, for example, so that the cameras 38-1 to 38-m may be provided so as to be able to pickup a facial image of the player within a reading range 6 as shown in FIG. 5.

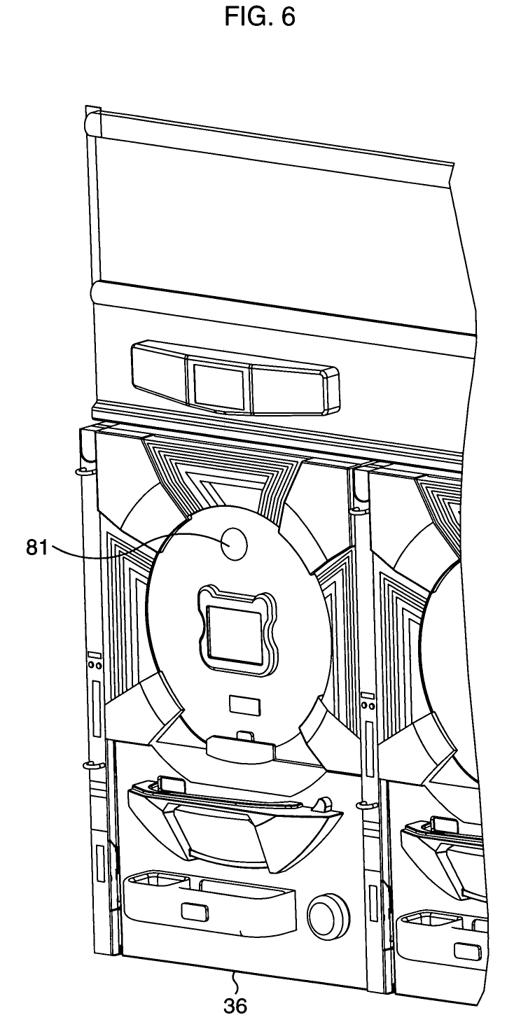

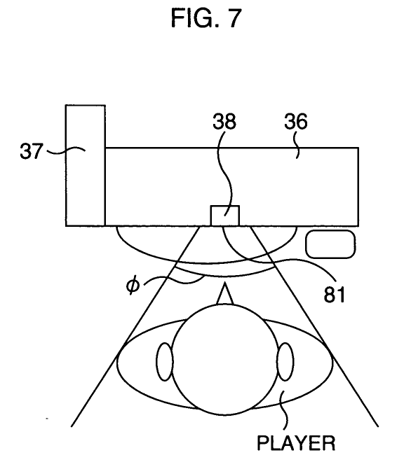

In addition, the cameras 38-1 to 38-m may be provided in the center of the gaming machines 36 (on the surface of the game board of the gaming machines 36) as shown in FIG. 6, for example, to permit image pickup. In other words, as a result of the cameras 36 being installed in the installation portion 81 in FIG. 6, an image of the player is picked up within the reading range Φ as shown in FIG. 7.

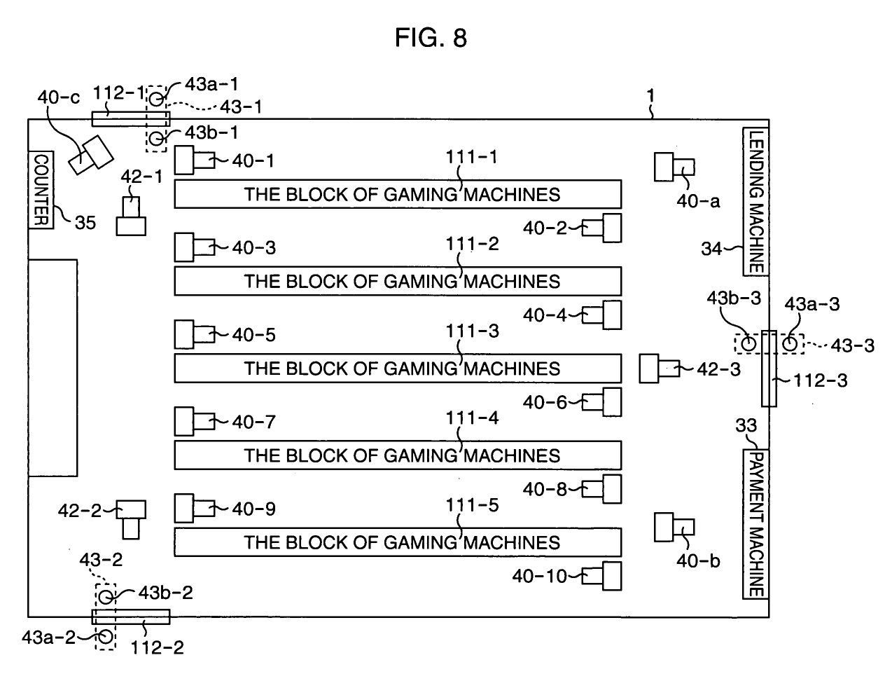

The in-store cameras 40-1 to 40-p and entrance cameras 42-1 to 42-q are installed in the doorways and in predetermined locations within the gaming facility 1 and supply picked up images to the image processing units 39-(m+1) to 39-(m+p) and entrance image processing units 41-1 to 41-q. Further, the entrance dual sensors 43-1 to 43-q are installed at the doorways 112 (FIG. 8) corresponding with the entrance cameras 42-1 to 42-q to detect the passage of players through the doorways 112 and supply the detection result to the entrance image processing units 41-1 to 41-q.

The in-store cameras 40-1 to 40-p, entrance cameras 42-1 to 42-q, and entrance dual sensors 43-1 to 43-q are installed as shown in FIG. 8, for example. FIG. 8 shows an example of the installation of the in-store cameras 40-1 to 40-p, entrance cameras 42-1 to 42-q, and entrance dual sensors 43-1 to 43-q in gaming facility 1.

In other words, in FIG. 8, doorways 112-1 to 112-3 are provided and entrance cameras 42-1 to 42-3 pickup images of player that come into the facility via the respective doorways 112. Further, in-store cameras 40-1 to 40-10 are established in positions enabling images of both sides of isle equipment 111-1 to 111-5 to be picked up over one column. The isle equipment 111 have gaming machines 36 installed on both sides thereof; in other words, the isle equipment 111 in FIG. 8 is installed so as to be vertically interposed between the gaming machines 36. Because all of the cameras 38, in-store cameras 40, and entrance cameras 42 have a pan, tilt, and zoom function, images of all the players that play at the gaming machines 36 can be picked by any of the in-store cameras 40-1 to 40-10 as a result of in-store cameras 40-1 to 40-10 being installed as shown in FIG. 8.

In addition, an in-store camera 40-a is provided in front of the lending machine 34, an in-store camera 40-b is provided in front of the payment machine 33 and an in-store camera 40-c is provided in front of the counter 35; each of which is capable of picking up an image of a player using the lending machine 34, payment machine 33, and counter 35.

In other words, as shown in FIG. 8, in gaming facility 1, the cameras 38, in-store cameras 40, and entrance cameras 42 are installed so as to be capable of monitoring substantially all the movements that players are assumed to make in gaming facility 1 such as players entering the facility, players playing at gaming machine 36, and player using the lending machine 34, payment machine 33, and counter 35.

In addition, an entrance dual sensor 43 is constituted by an external sensor 43a and an internal sensor 43b that are provided with the doorway 112 interposed therebetween; the external sensor 43a and internal sensor 43b each detect the passage of players by means of an optical sensor and, when a player is detected by the internal sensor 43b after the player has been detected by external sensor 43a, the external sensor 43a and internal sensor 43b detect the passage of the player through the doorway 112 and the fact that the player has entered the gaming facility 1.

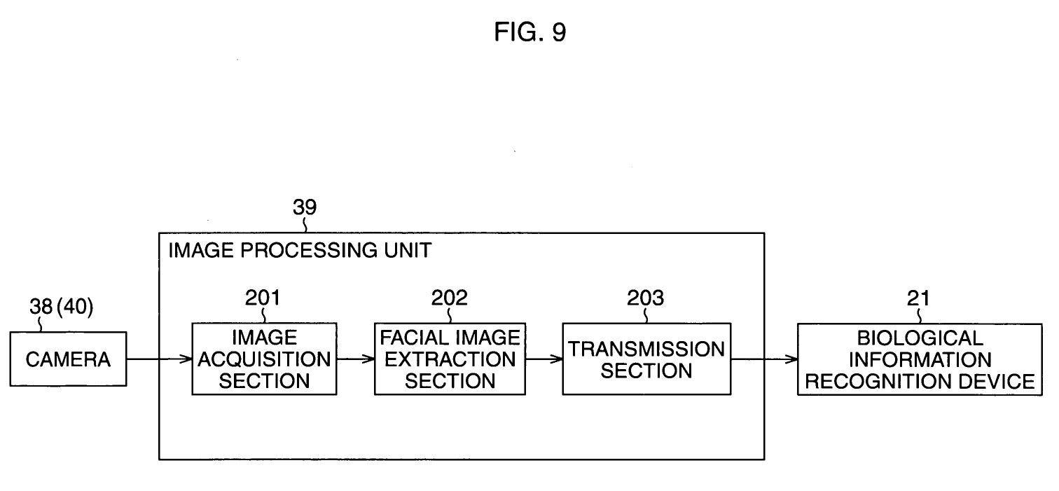

A constitutional example of the image processing unit 39 will be described next with reference to FIG. 9.

An image acquisition section 201 acquires images picked up by the cameras 38 (or in-store cameras 40) and supplies the images to a facial image extraction section 202. The facial image extraction section 202 extracts a rectangular image comprising a facial image by means of a pattern for the disposition of the parts constituting the face within the image supplied by the image acquisition section 201 and supplies the rectangular image thus extracted to a transmission section 203. The transmission section 203 transmits the facial image to the biological information recognition device 21.

A constitutional example of an entrance image processing unit 41 and the entrance dual sensor 43 will be described next with reference to FIG. 10. Further, the entrance image processing unit 41 in FIG. 10 basically comprises the same functions as those of the image processing units 39. For the entrance image processing unit 41 in FIG. 10, the same reference numerals are added to the same constitution as the constitution of the image processing units 39 in FIG. 9 and a description of the entrance image processing unit 41 is therefore suitably omitted.

A camera control section 221 comprises a pan-tilt-zoom control section 221a, a focus control section 221b, and an iris control section 221c and controls the pan-tilt-zoom control section 221a, focus control section 221b, and iris control section 221c respectively on the basis of the judgment result from a facial detection judgment section 222 to adjust the pan-tilt-zoom of the entrance camera 42, the focal position, and the iris. The facial detection judgment section 222 judges whether the facial image extraction section 202 is able to extract a facial image from an image picked up by the entrance camera 42 on the basis of an image from the image acquisition section 201 and the player passage judgment result from the entrance dual sensor 43 and, in cases where an image cannot be detected, the facial detection judgment section 222 controls a defective detection information generation section 224 to generate defective detection information and supply same to the biological information recognition device 21. Further, the facial detection judgment section 222 controls a video recording section 223 to record images that are supplied by the image acquisition section 201 successively in the memory 223a when it is judged whether the facial image can be detected. The defective detection information generation section 224 reads an image that has been recorded to memory 223a of the video recording section 223 when defective detection information is generated as a result of the judgment that extraction of the facial image is impossible by the facial detection judgment section 222 when detection of the facial image is impossible, and generates defective detection information.

The external sensor 43a of the entrance dual sensor 43 is an optical sensor and, as shown in FIG. 8, is provided on the side of the doorway 112 of the gaming facility 1 that is outside the facility. Upon sensing the passage of the player, the external sensor 43a supplies a predetermined signal to an external sensor sensing section 231. When the predetermined signal is supplied by the external sensor 43a, the external sensor sensing section 231 supplies an ON signal indicating the passage of the player past the external sensor 43a to a passage judgment section 233 and an OFF signal is supplied thereto at other times.

The internal sensor 43b in the entrance dual sensor 43 is an optical sensor and is provided on the side of the doorway 112 on the inside of the gaming facility 1 as shown in FIG. 8. Upon detecting the passage of the player, the internal sensor 43b supplies a predetermined signal to an internal sensor sensing section 232. When a predetermined signal is supplied by the internal sensor 43b, the internal sensor sensing section 232 supplies an ON signal indicating the passage of the player past the internal sensor 43b to the passage judgment section 233 and an OFF signal is supplied thereto at other times.

The passage judgment section 233 judges whether the player has passed the doorway 112 on the basis of the timing of the ON or OFF of the signal supplied by the external sensor sensing section 231 and internal sensor sensing section 232. When it is judged that the player has passed the doorway 112, a signal indicating that fact is supplied to the facial detection judgment section 222 of the entrance image processing unit 41. More specifically, the passage judgment section 233 detects the passage of the player when the signal supplied by the external sensor sensing section 231 changes from an OFF state to an ON state and then turns OFF and then, when the signal supplied by the internal sensor sensing section 232 changes from an OFF state to an ON state and then turns OFF.

An example of the constitution of the biological information recognition device 21 will be described next with reference to FIG. 11.

A facial image acquisition section 251 acquires facial images that are supplied by the image processing units 39 or entrance image processing units 41 and supplies these images to a checking section 252. The checking section 252 checks a facial image acquired from the facial image acquisition section 251 against a facial image that has been pre-registered in the biological information database 22 and, if a facial image that is a highly similar candidate is present in the biological information database 22, the checking section 252 displays facial image candidates as far as a third candidate on the display section 23 as the checking result. Further, the checking section 252 supplies the supplied facial image to an unregistered player database registration section 253 when a facial image which is a highly similar candidate does not exist.

More precisely, a feature extraction section 271 of the checking section 252 extracts a feature for identifying a facial image and supplies the feature to a similarity calculation section 272 together with the facial image. The similarity calculation section 272 extracts the feature of the facial image of the registered player registered in the biological information database 22 and uses the feature supplied by the feature extraction section 271 to determine the similarity with the facial images all the registered player registered in the biological information database 22; the similarity calculation section 272 supplies the facial image supplied by the facial image acquisition section 251 and similar facial images up to the third-ranked facial image to a similarity judgment section 273. More specifically, the similarity calculation section 272 determines a differential sum, mean percentage, or percentage sum or the like on the basis of facial feature of various types such as the distance between the eyes, the length from the chin to the forehead, the length from the chin to the nose, for example.

The similarity judgment section 273 compares the similarity with the facial image in first position among the respective similarities of the facial images up to the third-ranked facial image that have been supplied by the similarity calculation section 272 with a predetermined threshold value and when, based on the result of the comparison, the registered facial image in first position is similar to the facial image supplied by the facial image acquisition section 251 (a similarity indicating a high degree of similarity is higher than the predetermined threshold value and a similarity representing a low degree of similarity is lower than the predetermined threshold value), the similarity judgment section 273 supplies information on the similarity with the third-ranked facial image to the display section 23 so that the information is displayed by the display section 23 and supplies the information to a communication section 254. Further, the similarity judgment section 273 compares the similarity with the facial image in first position with a predetermined threshold value and, based on the result of the judgment, when the registered facial image in first position is not similar to the facial image supplied by the facial image acquisition section 251, the similarity judgment section 273 supplies the facial image supplied by the facial image acquisition section 251 to the unregistered player database registration section 253.

The unregistered player database registration section 253 registers the facial image in the unregistered player DB 351 of the biological information management database 3 that has been supplied as a result of the player with the facial image being regarded as unregistered by the checking section 252.

An operation section 255 is constituted by buttons, a mouse, or a keyboard or the like and is operated when any of the earlier-mentioned facial images up to the third-ranked facial image which are displayed on the display section 23 is selected. The result of operating the operation section 255 is supplied to a communication section 254. The communication section 254 is constituted by a modem or the like and distributes the selected facial image to a portable terminal 44 on the basis of an operation signal from the operation section 255.

Further, here, an example will be described where the similarity represents a higher value the closer a facial image is to the facial image registered for a registered player as indicated by the percentage sum, for example, and, when the similarity is a higher value than the predetermined threshold value, the facial image is judged to be a facial image of the registered player that corresponds with the similarity. However, in cases where the similarity is expressed as the differential sum of the respective characteristic values of a picked up facial image and facial images registered for the registered players, for example, the similarity judgment section 273 comes to regard the picked up facial image as the facial image of the registered player if the similarity is less than the threshold value or, in the case of a mean percentage or the like, the player can be regarded as the same person if the mean percentage is close to 1, which is equal to or more than a predetermined value in the range 0 to 1.

When a new registered player database 352 (FIG. 12) is distributed by the biological information management center 2, the database management section 256 updates the biological information database 22 on the basis of the new registered player database 352.

A defective detection information acquisition section 257 acquires and accumulates defective detection information that is supplied by the entrance image processing unit 41. When defective detection information has accumulated in the defective detection information acquisition section 257, a defective detection information image display control section 258 generates a video recording list image from the defective detection information on the basis of the defective detection information and displays same on the display section 23; when playback of a predetermined image is instructed, the defective detection information image display control section 258 reads the corresponding image information by means of the defective detection information acquisition section 257 and displays this information on the display section 23.

A constitutional example of the biological information management center 2 will be described next with reference to FIG. 12.

The biological information management center 2 is constituted by a DB distribution section 341, a DB update section 342, and a DB update judgment section 343 and updates the registered player DB 352 stored in the biological information management database 3 on the basis of an unregistered player DB 351. More specifically, the DB update judgment section 343 contains an RTC (Real Time Clock) 343a that produces time information and, when a predetermined time has elapsed on the basis of the built-in RTC 343a, the DB update judgment section 343 accesses the biological information management DB 3 and judges whether a new unregistered player has been registered in the unregistered player DB 351.

When an unregistered player is newly registered in the unregistered player DB 351, the DB update judgment section 343 communicates this fact to the DB update section 342. The DB update section 342 accesses the unregistered player DB 351 and judges whether an unregistered player that has been registered a predetermined number of times or more exists among the unregistered players thus registered. In cases where an unregistered player that has been registered as an unregistered player a predetermined number of times or more exists, the DB update section 342 reads the registered player DB 352 and registers and updates the unregistered player registered a predetermined number of times or more in the registered player DB 352. In addition, when the registered player DB 352 is updated, the DB update section 342 communicates the fact that the registered player DB 352 has been updated to the DB distribution section 341.

When the fact that the registered player DB 352 has been updated by the DB update section 342 is communicated, the DB distribution section 341 accesses the biological information management database 3, reads the registered player DB 352, and distributes same to the biological information recognition devices 21 of the respective gaming facilities 1.

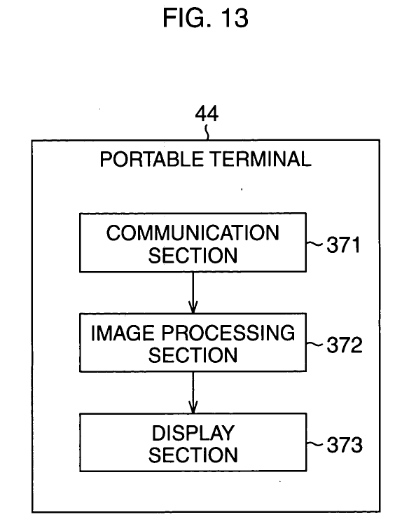

A constitutional example of the portable terminal 44 will be described next with reference to FIG. 13.

A communication section 371 is constituted by a modem or the like and exchanges data with the biological information recognition device 21 via a wireless communication network in the gaming facility 1. Further, the communication section 371 acquires information indicating the fact that a player with a facial image that is similar to a facial image supplied by the image processing units 39 or entrance image processing units 41 that have been distributed by the biological information recognition device 21 has arrived at the facility and supplies this information to the image processing section 372.

The image processing section 372 generates an image that is displayed on a display section 373 that is constituted by an LCD or the like on the basis of information indicating the fact that a player with a facial image that is similar to a facial image supplied by an image processing unit 39 or entrance image processing unit 41 that has been supplied by the communication section 371 has arrived at the facility and displays the image thus generated on the display section 373.

The processing to monitor the arrival at the facility of a registered player will be described next with reference to the flowchart in FIG. 14. Although a description will be provided herein below for processing in which the entrance image processing unit 41 is used by the entrance camera 42, the same processing can also be implemented with the involvement of the image processing unit 39 by means of the camera 38 or in-store camera 40.

In step S1, the entrance camera 42 judges whether the door to the entrance is open on the basis of the information of a picked up image or a signal from the entrance door and this processing is repeated until a predetermined time has elapsed.

In cases where it is judged that the door is open in step S1, the entrance camera 42 picks up images in the installation range in step S2 and supplies the picked up images to the entrance image processing unit 41. The image acquisition section 201 of the entrance image processing unit 41 acquires the images thus supplied and supplies these images to the facial image extraction section 202.

In step S3, the facial image extraction section 202 extracts the facial images of players from the images thus supplied and supplies the extracted images to the transmission section 203. More specifically, the facial image extraction section 202 extracts facial images from the arrangement of characteristic parts such as the eyes and nose which are parts in which the skin is exposed from the color and so forth of the picked up images and supplies the facial images to the transmission section 203.

In step S4, the transmission section 203 transmits the facial images that have been supplied by the facial image extraction section 202 to the biological information recognition device 21. Thereupon, the transmission section 203 adds information such as the camera IDs for identifying the camera 38, in-store camera 40, and entrance camera 42 and transmission time information to the facial images before transmitting the facial images to the biological information recognition device 21.

In step S21, the facial image acquisition section 251 of the biological information recognition device 21 acquires the facial images. In step S22, the facial image acquisition section 251 extracts any one unprocessed image among the supplied facial images and supplies same to the facial feature extraction section 271.

In step S23, the facial feature extraction section 271 of the checking section 252 extracts facial feature from the facial images thus supplied and supplies the facial feature to the similarity calculation section 272 together with the facial images.

In step S24, the similarity calculation section 272 calculates, as the similarity, the differential sum, the mean percentage, or the percentage sum or the like by determining facial feature of various types such as the ratio between the distance between the eyes, the length from the chin to the forehead, and the length from the chin to the nose and so forth for the facial images supplied by the facial feature extraction section 271 and determines the ranking order of similarities which constitute the calculation results; the similarity calculation section 272 then supplies the facial images up to the third-ranked facial image and similarity information to the similarity judgment section 273 together with the facial images supplied by the facial feature extraction section 271.

In step S25, the similarity judgment section 273 judges whether the highest similarity is greater than a predetermined threshold value on the basis of the facial images up to the third-ranked facial image and the similarity information that have been supplied by the similarity calculation section 272. That is, the similarity judgment section 273 compares the similarity of the most similar registered player (the registered player most similar to the facial image acquired by the facial feature extraction section 271 among the facial images registered in the biological information database 22: here, the registered player of the highest similarity) with a predetermined threshold value.

Thus, as mentioned earlier, according to the definition of similarity, the similarity of the facial image of a registered player most similar to the facial image pickedup is not limited to the similarity with the highest value; the magnitude correlation between the similarity and threshold value sometimes differs from the case provided in this example.

In step S26, the similarity judgment section 273 displays a report screen 401 that shows that the third-ranked facial image supplied by the similarity calculation section 272 is a candidate for the facial image of a registered player by controlling display section 23.

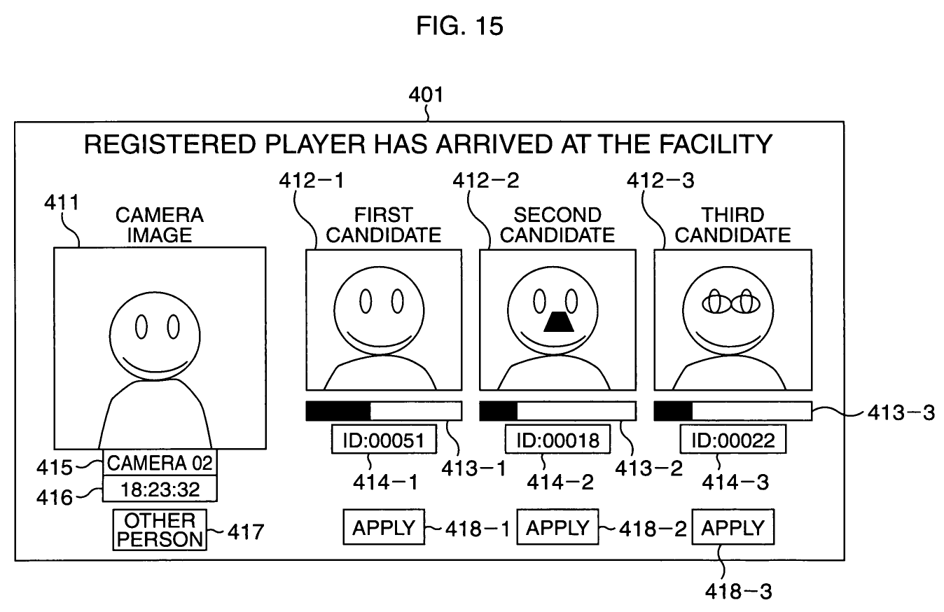

Thereupon, the report screen 401 shown in FIG. 15, for example, is displayed on the display section 23.

In the report screen 401 in FIG. 15, a camera image display field 411 is provided in the center on the left and displays a facial image that has been supplied by the entrance image processing unit 41. Further, to the right of the camera image display field 411, facial image display fields 412-1 to 412-3 for registered players ranked in the top three positions of similarity which are the first to third candidates starting with the most similar are provided. In addition, similarity level display fields 413-1 to 413-3 are provided below the facial image display fields 412-1 to 412-3 of the respective registered players and display the similarity levels. In FIG. 15, the length in the horizontal direction of the region shown in black illustrates the magnitude of the similarity.

Furthermore, below the similarity level display fields 413-1 to 413-3, the ID display fields 414-1 to 414-3 are provided in corresponding positions, and the IDs identifying the facial images in the biological information database 22 of the respective facial images are displayed and, in FIG. 15, ‘00051’, ‘00018’, and ‘00022’, are displayed starting from the left.

In addition, ‘Apply’ buttons 418-1 to 418-3 which are operated by the operation section 255 when selecting the respective candidates are provided below the ID display fields 414-1 to 414-3 in respective corresponding positions.

Further, a camera ID display field 415 that identifies the camera that picked up the facial image is provided below the camera image display field 411. In FIG. 15, ‘camera 02’ is displayed as the camera ID for identifying the camera 38, in-store camera 40 and entrance camera 42. A timed is play field 416 is provided below the camera ID display field 415 and displays the time picked up by the entrance camera 42. In FIG. 15, ‘18:23:32’ is displayed which shows that the facial image of the camera image display field 411 was picked up at 18 hours, 23 minutes and 32 seconds.

In addition, an other person button 417 is provided below the time display field 416. The other person button 417 is operated by the operation section 255 when the facial image of the camera image is not regarded as being similar to any of the facial image display fields 412-1 to 412-3 of registered players who are the first to third candidates.

In step S27, the communication section 254 is operated by the operation section 255 and it is judged whether any of the candidate facial images has been selected, that is, it is judged whether any of the Apply buttons 418-1 to 418-3 has been operated by the operation section 255 when the report screen 401 shown in FIG. 15 is displayed on the display section 23, for example.

In step S27, when the Apply button 418-1 has been operated, for example, it is considered that the first candidate has been selected and, in step S28, the communication section 254 transmits the selected first candidate facial image and the camera image picked up by the entrance camera 42 to the portable terminal 44 and communicates the fact that the relevant registered player has come to the gaming facility.

In step Second optical system 41, the communication section 371 judges whether the fact that a registered player has arrived at the facility has been communicated and repeats the processing until such a communication is made. For example, in step S41, when the fact that a registered player has arrived at the facility has been communicated as a result of the processing of step S28, in step S42, the communication section 371 receives the communication that a registered player has arrived at the facility that was transmitted by the biological information recognition device 21 and supplies the facial image of the registered player and the camera image picked up by the entrance camera 42 which are transmitted together with the communication to the image processing section 372. The image processing section 372 processes the information of the selected facial image and the camera image picked up by the entrance camera 42 to produce information in a format that can be displayed on the display section 373 and, in step S43, displays the information on the display section 373.

As a result of the above processing, when clerk in the gaming facility 1 is in possession of the portable terminal 44, they are able to acknowledge the arrival at the facility of the registered player.

Further, in step S29, the facial image acquisition section 251 judges whether processing has been executed with respect to all of the supplied facial images and, when there is an unprocessed facial image, the processing returns to step S22. That is, until processing has been executed for all the facial images, the processing of steps S22 to S30 is repeated. Further, when it is judged that the processing of all the facial images has ended, the processing returns to step S21.

Meanwhile, in step S27, in cases where no candidate facial image is selected and the other person button 417 of the report screen 401 in FIG. 15, for example, is pushed down or, in step S25, in cases where, based on the information for the facial images in the top three positions supplied by the similarity calculation section 272 and the similarity information, the highest similarity is not greater than the predetermined threshold value, that is, in cases where the similarity is less than the predetermined threshold value even for the facial image of the most similar registered player, in step S30, the similarity judgment section 273 supplies the facial image that was supplied by the image processing unit 39 to the unregistered player database registration section 253. The unregistered player database registration section 253 accesses the biological information management database 3 via the biological information management bus 6 and public communication network 8 and registers the supplied facial image in the unregistered player DB 351.

As a result of the above processing, when the facial image supplied by the entrance image processing unit 41 is regarded by the biological information recognition device 21 as not being registered in the biological information database 22, the facial image is registered as the facial image of an unregistered player in the unregistered player DB 351 in the biological information management database 3 managed by the biological information management center 2.

The processing to update the registered player DB 352 will be described next with reference to the flowchart in FIG. 16.

In step S61, the DB update judgment section 343 of the biological information management center 2 judges whether a predetermined time has elapsed by consulting the RTC 343a and repeats the processing until a predetermined time has elapsed. For example, when it is judged that the predetermined time has elapsed in step S61, in step S62, the DB update judgment section 343 accesses the unregistered player DB 351 of the biological information management database 3 and judges whether a new unregistered player has been registered, repeating the processing of steps S61 and S62 until a new unregistered player has been registered.

In step S62, in cases where a new unregistered player has been registered by the processing of step S30, for example, in step S63, the DB update judgment section 343 judges whether any of the unregistered players newly registered in the unregistered player DB 351 has been registered a predetermined number of times. When the number of registrations is not equal to or more than the predetermined number of times, the processing returns to step S61.

Meanwhile, in cases where it is judged in step S63 that an unregistered player who has been registered in the unregistered player DB 351 a number of times equal to or more than the predetermined number of times exists, for example, in step S64, the DB update judgment section 343 communicates the fact that a state where an update to the registered player DB 352 is to be performed to the DB update section 342. By way of response, the DB update section 342 accesses the unregistered player DB 351 and reads all of the information of the facial image of the unregistered player that has been registered a predetermined number of times or more, accesses the registered player DB 352, and adds an ID identifying the facial image to the information of the facial image of the unregistered player that has been registered predetermined number of times or more thus read, before newly registering and updating the unregistered player in the registered player DB 352. In addition, the DB update section 342 communicates the fact that the registered player DB 352 has been updated to the DB distribution section 341. Further, at the point where an update to the registered player DB 352 has ended, the unregistered player that has been registered a predetermined number of times or more is deleted from the unregistered player DB 351.

In step S65, the DB distribution section 341 accesses and reads the newly updated registered player DB 352 of the biological information management database 3 and distributes the registered player DB 352 which is read to the database management section 256 of the biological information recognition device 21.

In step S81, the database management section 256 judges whether the new registered player DB 352 which has been updated by the biological information management center 2 has been distributed and repeats the processing until the new registered player DB 352 has been distributed.

In step S81, when the newly updated registered player DB 352 is distributed by the DB distribution section 341 of the biological information management center 2 by means of the processing of step 65, for example, in step S82, the database management section 256 acquires the registered player DB 352 that has been distributed and updates the biological information database 22 on the basis of the information of the registered player DB 352. More precisely, the database management section 256 copies the information of the newly distributed registered player DB 352 to the biological information database 22 so that the information therein is overwritten.

As a result of the above processing, when an unregistered player is registered as an unregistered player in the unregistered player DB 351 a predetermined number of times or more at any of the gaming facilities 1-1 to 1-n, because the unregistered player is registered in the form of a database in the biological information database 22 of the biological information recognition device 21 of any of the gaming facilities 1-1 to 1-n by newly registering the unregistered player in the registered player DB 352, when an image of the unregistered player is picked up by the entrance camera 42 at a plurality of gaming facilities 1, it turns out that the arrival of the player at the gaming facility is reported as that of a registered player. Furthermore, the registered player DB 352 is updated on the basis of the information from the respective gaming facilities 1-1 to 1-n. Hence, a customer facility arrival recording is generated for a plurality of facilities and the customer facility arrival recordings can be centrally managed.

The above description was for an example in which, as shown by the processing of step S1 in the flowchart of FIG. 14, it is judged whether a registered player has arrived at the facility by checking the facial image of an image picked up with the timing at which the player arrives at the facility against the facial images of the biological information database 22 which is the same database as the registered player DB 352. In cases where the arriving player is not a registered player, the player is registered in the unregistered player DB 351 as an unregistered player. When the player has been registered as an unregistered player a predetermined number of times, the player is registered in the registered player DB 352. The timing with which the image is picked up is not limited to the timing at which the player arrives at the facility. For example, the image may also be picked up by the camera 38 or in-store camera 40 at the point where it is detected that a bank note is jammed in the gaming machine peripheral terminal 37 or when an abnormal operation such as the detection of the jamming of a ball or medal in a gaming machine 36 is detected so that a specified player is registered at the point the abnormal operation occurs and, in cases where the abnormal operation is utilized for the purpose of improper conduct, for example, this can be exposed.

Furthermore, although an example in which, as indicated by the processing of step S1 in the flowchart in FIG. 14, a facial image is extracted with the timing at which a door opens, was described hereinabove, the timing of the image pickup is not particularly determined; the facial image checking may also be performed once a facial image has been extracted while image pickup is in progress.

As detailed earlier, it is possible to implement the collection of not only customer facility arrival information for the respective facilities but also customer facility arrival recordings at a plurality of facilities and implement centralized management thereof.

Entrance camera adjustment processing will be described next with reference to the flowchart in FIG. 17.

In step S101, the camera control section 221 of the entrance image processing unit 41 controls the pan-tilt-zoom control section 221a, focus control section 221b, and iris control section 221c to adjust the entrance camera 42 to the pan, tilt, and zoom as well as the focal position and iris which are each set to their default values.

In step S102, the facial detection judgment section 222 executes facial detection judgment processing and judges whether the extraction of a facial image from the image is possible on the basis of the image that is supplied to the facial image extraction section 202 by the image acquisition section 201.

Facial detection processing will be described here with reference to the flowchart in FIG. 18.

In step S121, the facial detection judgment section 222 resets the passing people counter T and the facial detection people counter K.

In step S122, the recording of images supplied by the image acquisition section 201 is started and the recorded images are made to accumulate sequentially in the memory 223a by controlling the video recording section 223.

In step S123, the passage judgment section 233 of the entrance dual sensor 43 judges whether a signal indicating that the external sensor 43a is ON has been input by the external sensor sensing section 231 and repeats the processing until a signal indicating that the external sensor 43a is ON has been input.

In step S123, when the external sensor 43a installed outside the doorway 112 of the gaming facility 1 detects the passage of a player, for example, produces a predetermined signal and supplies same to the external sensor sensing section 231, the external sensor sensing section 231 supplies a signal indicating that the external sensor 43a is ON to the passage judgment section 233. As a result, the passage judgment section 233 judges that the external sensor 43a is ON and the processing moves on to step S124.

In step S124, the passage judgment section 233 of the entrance dual sensor 43 judges whether a signal indicating that the external sensor 43a is OFF has been input by the external sensor detection section 231 and repeats the processing until a signal indicating that the external sensor 43a is OFF has been input.

In step S124, as result of a player completely passing through the range in which sensing by the external sensor 43a is possible, for example, the external sensor 43a installed on the outside of the doorway 112 of the gaming facility 1 enters a state where the player is not detected and, when the production of the predetermined signal is stopped, the external sensor sensing section 231 supplies a signal indicating that the external sensor 43a is OFF to the passage judgment section 233. As a result, the passage judgment section 233 judges that the external sensor 43a is OFF and the processing moves on to step S125.

In step S125, the passage judgment section 233 of the entrance dual sensor 43 judges whether a signal indicating that the internal sensor 43b is ON has been input by the internal sensor sensing section 232 and repeats the processing until a signal indicating that the internal sensor 43b is ON is input.

In step S125, for example, when the internal sensor 43b installed on the inside of the doorway 112 of the gaming facility 1 detects the passage of the player, produces a predetermined signal, and supplies same to the internal sensor sensing section 232, the internal sensor sensing section 232 supplies a signal indicating that the internal sensor 43b is ON to the passage judgment section 233. As a result, the passage judgment section 233 judges that the internal sensor 43b is ON and the processing moves on to step S126.

In step S126, the passage judgment section 233 of the entrance dual sensor 43 judges whether a signal indicating that the internal sensor 43b is OFF has been input by the internal sensor sensing section 232 and repeats the processing until a signal indicating that the internal sensor 43b is OFF has been input.

In step S126, as a result of a player completely passing through the range in which sensing by the internal sensor 43b is possible, for example, the internal sensor 43b installed on the inside of the doorway 112 of the gaming facility 1 enters a state where the player is not detected and, when the production of the predetermined signal is stopped, the internal sensor sensing section 232 supplies a signal indicating that the internal sensor 43b is OFF to the passage judgment section 233. As a result, the passage judgment section 233 judges that the internal sensor 43b is OFF and the processing moves on to step S127.

In step S127, the passage judgment section 233 communicates the fact that a player has passed through the doorway 112 and entered the gaming facility to the facial detection judgment section 222. In other words, as indicated by the judgment processing of steps S123 to S126, a respective detection state ends after the passage of the player has been detected by the internal sensor 43a, and a respective detection state ends after the passage of the player has been detected by the internal sensor 43b, where by the passage of the player through the doorway 112 of the gaming facility 1 from the outside into the gaming facility is detected.

In step S128, the facial detection judgment section 222 increases the passing people counter T by one on the basis of the communication indicating the passage of the player through the doorway 112 from the passage judgment section 233.

In step S129, the facial detection judgment section 222 detects a facial image by means of the same technique as the technique for extracting a facial image of the facial image extraction section 202 from the image supplied by the image acquisition section 201. Further, the timing with which the image is supplied by the image acquisition section 201 is the timing at which the processing of steps S2 and S3 in FIG. 14 are executed.

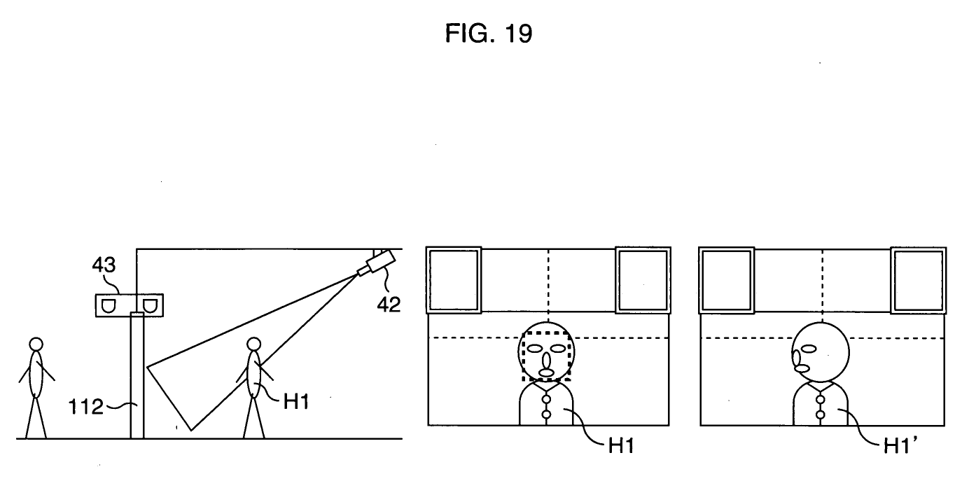

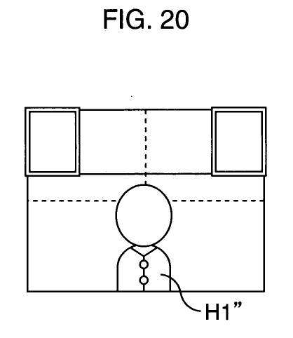

In step S130, the facial detection judgment section 222 judges whether a face can be detected from the image supplied by the image acquisition section 201, in other words, whether a facial image can be extracted. As shown on the left side of FIG. 19, for example, the facial detection judgment section 222 judges that a face can be detected in cases where the image picked up by the player H1 that has entered the facility via the doorway 112 in the image pickup range of the entrance camera 42 is an image in which parts constituting the face such as the eyes, nose, and mouth can be adequately recognized as shown in the center of FIG. 19. Furthermore, as shown by the player H1′ on the right side of FIG. 19, in cases where the face is not oriented toward the entrance camera 42, the facial detection judgment section 222 judges that a face cannot be detected. In addition, in cases where, as shown by the player H1″ in FIG. 20, the face in the image is not in the focal position and the parts constituting the face such as the eyes, nose, and mouth cannot be adequately recognized, the facial detection judgment section 222 judges that the face cannot be detected.

In step S130, in cases where it is judged that the face has been detected, in step S131, the facial detection judgment section 222 increases the facial detection people counter K by one. However, when it is judged that the face cannot be detected, the processing in step S131 is skipped.

In step S132, the facial detection judgment section 222 judges whether the passing people counter T is equal to or more than a predetermined threshold value Tth and in cases where the passing people counter T is not equal to or more than the threshold value Tth, for example, the processing returns to step S123 and the processing of steps S123 to S132 is repeated. In step S132, when judgment processing to determine whether the passing people counter T is equal to or more than the threshold value Tth, in other words, whether the faces corresponding to the predetermined threshold value Tth are detected, in step S133, the facial detection judgment section 222 calculates the facial detection ratio R (=facial detection people counter K/threshold value Tth). In other words, the facial detection ratio R, which indicates the ratio of the faces that can be detected with respect to the number of people entering the facility via the doorway 112, is calculated.

In step S134, the facial detection judgment section 222 judges whether the facial detection ratio R is equal to or more than a predetermined threshold value Rth. In step S134, in cases where the facial detection ratio R is equal to or more than the predetermined threshold value Rth, in other words, in cases where the ratio of the detected faces with respect to the number of people entering the facility via the doorway 112, the facial detection judgment section 222 judges in step S135 that the face is in an adequately detectable state.

However, in step S134, in cases where the facial detection ratio R is not equal to or more than the predetermined threshold value Rth, in other words, in cases where the ratio of faces that can be detected with respect to the number of people entering the facility via the doorway 112 is low, in step S136, the facial detection judgment section 222 is judged as being in a state in which faces cannot be adequately detected.

In step S137, the facial detection judgment section 222 controls the video recording section 223 to stop video recording and images that are continuously recorded after the video recording is started by the processing of step S122 are recorded as one file to the memory 223a, whereupon the processing is stopped.

As a result of the above processing, when processing to detect the faces of a number of people equal to a predetermined number of passing people (the number of people corresponding to the predetermined threshold value Tth) is detected, the facial detection ratio R is determined and it is judged that faces can be adequately detected when the facial detection ratio R is high and it is judged that faces cannot be detected when the facial detection ratio R is low.

In FIG. 18, with respect to a description for finding the facial detection ratio R, although the description was provided by including all the processing in the same flowchart, because the entrance dual sensor 43 operates individually, when the processing is established as a flow chart in which the processing of steps S123 to S127 are independent, and when the passage of a player is detected by the entrance dual sensor 43 in this processing, the passing people counter T may be increased by one. Further, the processing of steps S129 to S131 not only detects one facial image of one person from one image but may also detect, from a plurality of images, a plurality of facial images for the respective images or may increase the facial detection counter K by one so that facial images of the same person are not repeated. The decision with regard to whether a facial image can be detected from an image that is input may utilize the result with regard to whether a facial image can actually be detected by the facial image extraction section 202.

Let us now return to the description of the flowchart in FIG. 17.

In step S103, the facial detection judgment section 222 judges whether a state where adequate facial detection is possible through facial detection processing exists. For example, in cases where it is judged by the processing of step S135 that a face can be adequately detected, in step S104, the facial detection judgment section 222 measures the brightness difference D between a suitable facial image and the facial image that was picked up.

In step S105, the facial detection judgment section 222 judges whether the brightness difference D is equal to or more than a predetermined threshold value Dth and, in cases where the brightness difference D is equal to or more than the predetermined threshold value Dth, for example, respective correction values for the pan-tilt direction, zoom magnification, and iris are calculated on the basis of the brightness difference D and the correction values thus calculated are supplied to the camera control section 221 in step S106.

In step S107, the camera control section 221 controls the pan-tilt-zoom control section 211a, focus control section 211b, and iris control section 221c in order to adjust same in accordance with the correction values, where upon the processing returns to step S102. In other words, the camera control section 221 corrects the pan-tilt direction, zoom magnification, focal length, and iris to suitable states under conditions permitting the adequate extraction of a facial image.

However, in step S105, in cases where the brightness difference D is not equal to or more than the predetermined threshold value Dth, it is considered that there is no need for such correction and the processing of steps S106 and S107 is skipped.

Furthermore, for example, in cases where it is judged in step S103 that a state permitting adequate detection through the processing of step S136 does not exist, in step S108, the facial detection judgment section 222 judges whether the control state of the camera 42 has been set to the final position that can be set as the focal position; when it is judged that the position is not the final position, the facial detection judgment section 222 instructs the camera control section 221 to change the focal position by one level in step S109. In response to the instruction, the camera control section 221 controls the pan-tilt-zoom control section 221a and focus control section 221b to establish the focal position of the entrance camera 42 in a position that is one stage further away from the entrance camera 42.

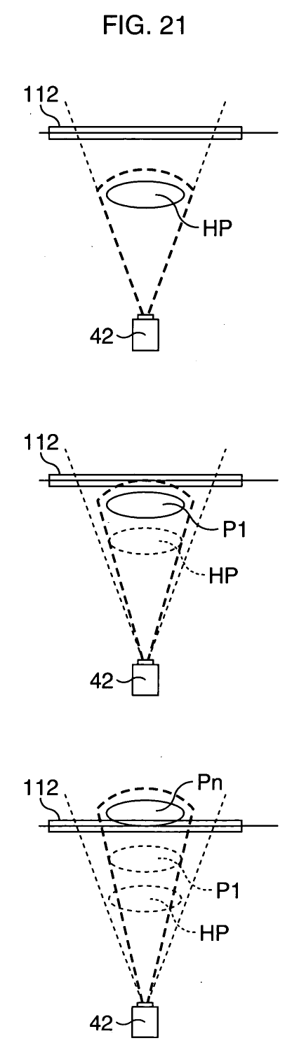

In other words, in the setting of the home position which is the default value (also known as the HP(Home Position) hereinafter), the entrance camera 42 is established in the focal position HP that is closest to the entrance camera 42 from the doorway 112 as shown at the top of FIG. 21, for example. This is because, when the direction of the doorway 112 is picked up by the entrance camera 42, the facial image does not grow dark due to the backlighting afforded by a closer position to the doorway 112 as opposed to a position directly after the player has passed through the doorway 112 and, not only is it possible to pickup a brighter image as a result of the in-store lighting but a facial image can also be picked up more clearly because the player is closer. However, it is a characteristic of people that they are often facing forward the moment the door provided in the doorway 112 is open and they have a tendency to move their face sideways as they advance into the facility. For this reason, there exists the tendency that, the closer the focal position is to the entrance camera 42, the more readily an image with which facial detection is difficult is produced.

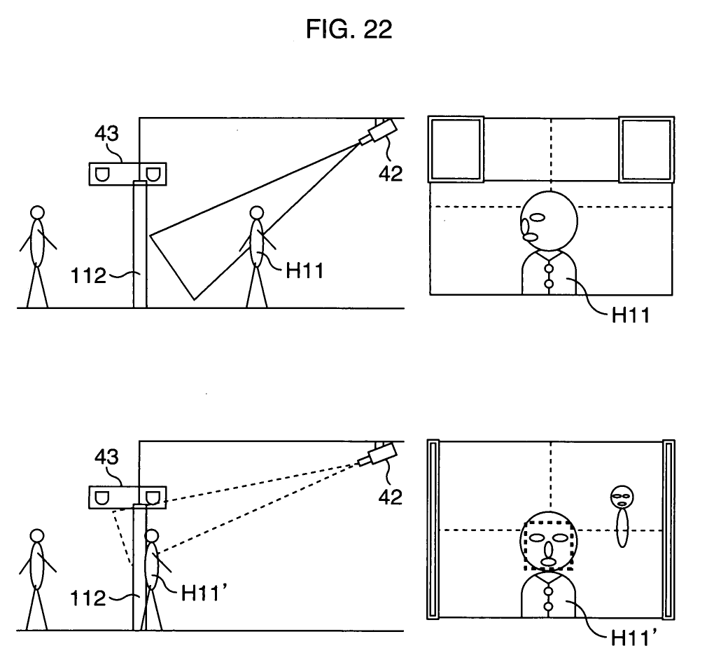

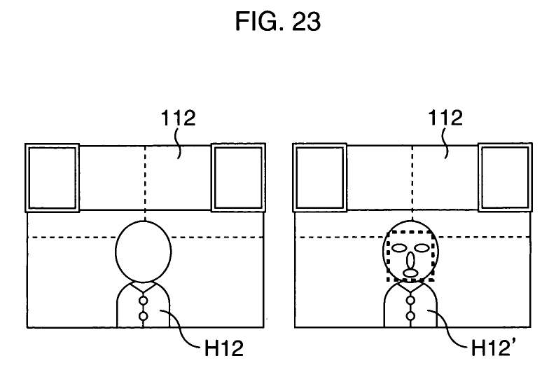

In a state where a facial image cannot be adequately detected, it can be considered that, as mentioned earlier, the player is at a distance from the doorway 112 and too close to the entrance camera 42. Therefore, in cases where adequate detection of a facial image is not possible, as shown in the middle of FIG. 21, the focal position is adjusted from the focal position HP to a position P1 that is spaced apart from the entrance camera 42 by a predetermined distance. As a result, as shown on the left side of FIG. 22, by changing the focal position from the position HP in which an image of a player H11 shown on the top right of FIG. 22 who is facing to the left of FIG. 22 is picked up to the position P1 spaced apart from the entrance camera 42 in order to change the pan-tilt-zoom direction of the entrance camera 42 as shown on the bottom left of FIG. 22, the probability of picking up an image of the player H11′ shown on the bottom right of FIG. 22 who is facing forward increases. In addition, the focal position of the entrance camera 42 is also accurately set in correspondence with the change in distance in order to produce a clear image of the parts such as the eyes, nose, and mouth constituting the face as shown for player H12′ shown on the right of FIG. 23 and avoid the player H12 shown on the left of FIG. 23 who is not in focus.

In cases where the face cannot be adequately detected by this processing, the focal position is moved away stepwise from the entrance camera 42 a predetermined distance at a time by the processing of steps S102, S103, S108, and S109. Further, once a state permitting adequate detection is assumed, in step S103, it is judged that a face can be adequately detected and the processing moves on to the processing of step S104 and subsequent steps.

However, the processing of steps S102, S103, S108, and S109 is repeated and, in cases where adequate detection is not possible even in the farthest position Pn for detecting the face by means of the entrance camera 42 as shown at the bottom of FIG. 21, in other words, even in the final position, it is judged in step S108 that the focal position has been established in the final position and, in step S110, the image detection judgment section 222 instructs the camera control section 221 to restore the focal position to position HP, which is the default position. Based on this instruction, the camera control section 221 establishes the focal position of the entrance camera 42 in position HP.

In step S111, the facial detection judgment section 222 judges whether one or more facial images can be detected, in other words, whether the facial detection people counter K is one or more by that point. When the facial detection people counter K is one or more, the fact that it can said that at least one facial image has been detected means that an anomaly has not been produced in the entrance camera 42 and the processing then moves on to step S104.

However, in step S111, in cases where the facial detection people counter K is not one or more, in other words, no facial images have been detected, it is considered that an anomaly has occurred in the entrance camera 42 and, in step S112, the facial detection judgment section 222 instructs the defective detection information generation section 224 to generate defective detection information. By way of response, the defective detection information generation section 224 reads data for images recorded thus far by the memory 223a of the video recording section 223, in other words, images that have been picked up by the processing of steps S122 and S137 of the flowchart in FIG. 18, generates defective detection information, and transmits same to the biological information recognition device 21 together with the camera ID.

As a result of the above processing, when a state where a face can be adequately detected exists, the pan-tilt-zoom, focal length, and iris which have been set are corrected to set values. When a state where adequate facial detection is possible does not exist, by changing the pan-tilt-zoom, focal length, and iris which have been set to conditions under which the face can be detected, the focal length is changed stepwise to a position far apart from the entrance camera 42 and, therefore, a facial image can be correctly extracted from the image picked up by the entrance camera 42. Further, in cases where facial detection is not possible even when adjustment is repeated while changing the focal position stepwise, it is considered that an anomaly has occurred in the entrance camera 42 and defective detection information can be generated and the anomaly of the entrance camera 42 can be detected.

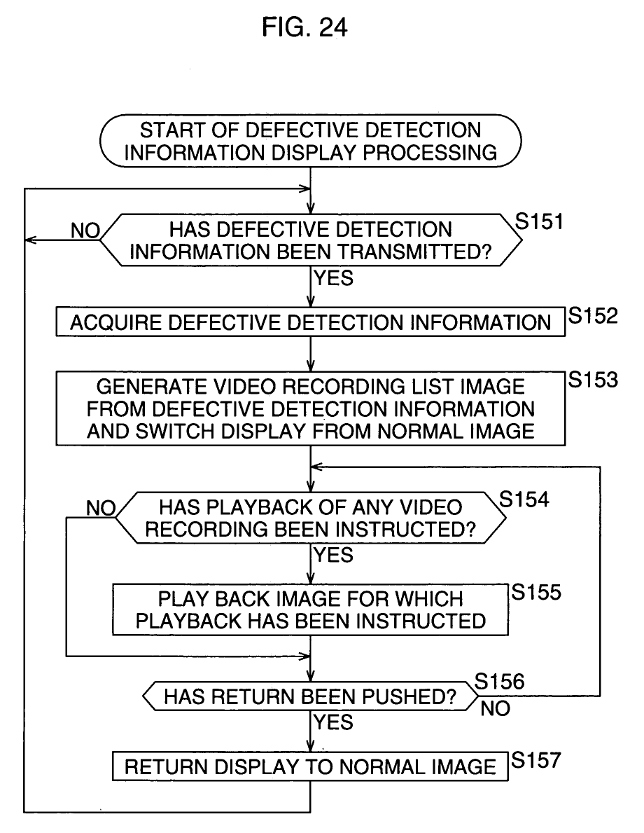

Processing to display defective detection information of the biological information recognition device 21 in cases where the defective detection information has been transmitted will be described next with reference to the flowchart in FIG. 24.

In step S151, the defective detection information acquisition section 257 of the biological information recognition device 21 judges whether defective detection information has been transmitted by the entrance image processing unit 41 and the processing is repeated until defective detection information has been transmitted. For example, in cases where defective detection information has been transmitted by the processing of step S112 of the flowchart in FIG. 17, the processing moves on to step S152.

In step S152, the defective detection information acquisition section 257 acquires and stores defective detection information that has been transmitted by the entrance image processing unit 41.

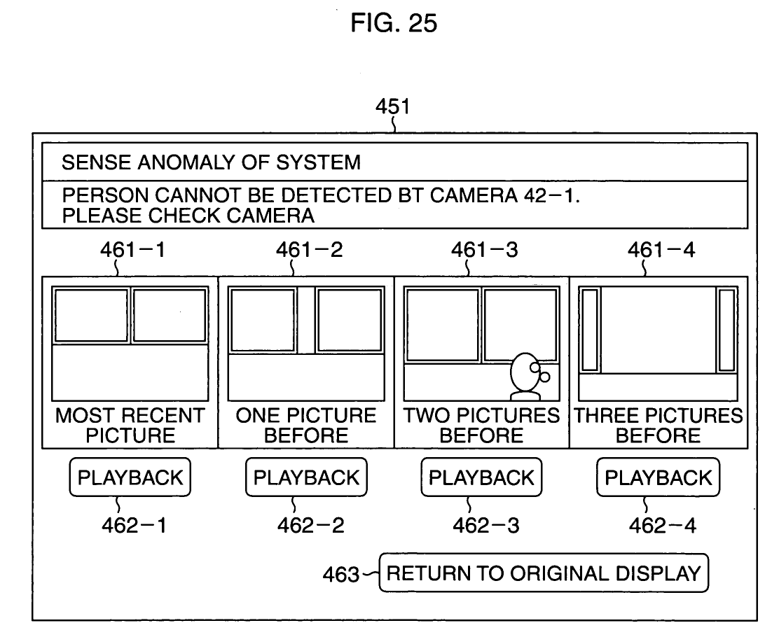

In step S153, the defective detection information image display control section 258 reads defective detection information that has been stored in the defective detection information acquisition section 257, generates a video recording list image 451 as shown in FIG. 25, for example, and displays the video recording list image 451 on the display section 23 by switching from the normal display screen shown in FIG. 15, for example.

In FIG. 25, ‘system anomaly sensed’ is displayed at the top of the video recording list image 451 and ‘person could not be detected by camera 42-1. Please check camera 42-1’, which indicates that an anomaly such that facial detection cannot be performed by camera 42-1 has occurred. The defective detection information image display control section 258 generates and displays the above sentence on the basis of the information of camera ID that was added to the defective detection information.

Further, video recording thumbnail display fields 461-1 to 461-4 which display a list of images contained in the defective detection information are displayed below the message display. ‘Most recent image’, ‘one image before’, ‘two images before’, and ‘three images before’ are displayed starting from the left and the leading frames of recorded images are displayed as thumbnail images, for example.

Playback buttons 462-1 to 462-4 are provided in correspondence with the video recording thumbnail display fields 461-1 to 461-4 below the video recording thumbnail display fields 461-1 to 461-4 and, when the respective images are played back, the playback operation is performed by means of the operation section 255. A Return button 463 that displays ‘return to original image’ is provided below and to the right of the video recording list image 451 and is operated by the operation section 255 when switching from the display screen of the video recording list image 451 to the normal display screen shown in FIG. 15, for example.

In step S154, the defective detection information image display control section 258 judges by consulting the operation section 255 whether the play back of any image has been instructed, in other words, whether any of the playback buttons 462-1 to 462-4 has been operated by the operation section 255. When playback button 462-1 has been operated, for example, the defective detection information image display control section 258 judges that playback has been instructed and, in step S155, the defective detection information image display control section 258 reads and plays back data of the image for which a playback instruction has been issued which are stored in the defective detection information acquisition section 257 and displays the data on the display section 23. In this case, because playback of the ‘latest image’ has been instructed, an image supplied by the image acquisition section 201 is played back while the processing of previous steps S122 to S137 is executed.

However, in cases where no playback is instructed in step S154, the processing of step S155 is skipped.

In step S156, the defective detection information image display control section 258 judges whether the Return button 463 has been operated by consulting the operation section 255 and, when the Return button 463 has not been operated, the processing returns to step S154.

However, in step S156, in cases where it is judged that the Return button 463 has been operated, in step S157, the defective detection information image display control section 258 stops displaying the video recording list image 451, returns to the normal display screen shown in FIG. 15, for example, and the processing returns to step S151.

As a result of the above processing, when the defective detection information is transmitted by the entrance image processing unit 41, the defective detection information is displayed and, therefore, when an anomaly occurs in the entrance camera 42, because this fact is communicated to the clerk of the gaming facility 1 managing the biological information recognition device 21, the anomaly of the entrance camera 42 can be rapidly recognized while monitoring the biological information recognition device 21.

As a result, it is possible to easily extract a facial image without increasing the number of cameras at the image pickup point and adjustment of individual cameras can be easily implemented. The image pickup state of the cameras can always be maintained in the optimum state and, therefore, facial image recognition processing can be more accurately implemented.

Further, the above-described serial monitoring processing can be executed by hardware but can also be executed by software. In cases where the serial processing is executed by software, the program constituting the software is installed via a recording medium on a computer incorporated in dedicated hardware or on a general-purpose personal computer or the like, for example, which is capable of executing various functions through the installation of various programs.

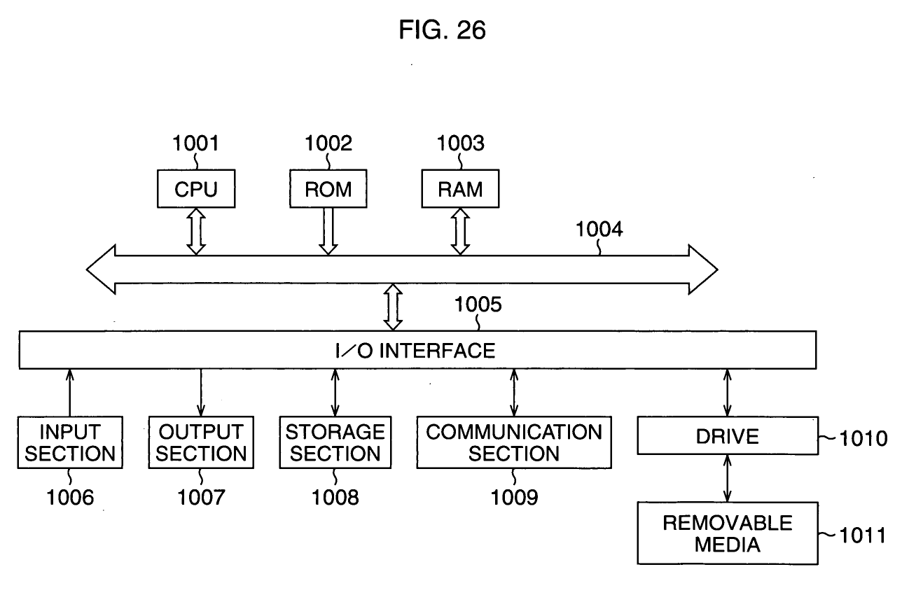

FIG. 26 shows a constitutional example of a general-purpose personal computer. This personal computer contains a CPU (Central Processing Unit) 1001. An IO interface 1005 is connected via a bus 1004 to the CPU 1001. A ROM (Read Only Memory) 1002 and RAM (Random Access Memory) 1003 are connected to the bus 1004.

Connected to the IO interface 1005 are an input section 1006 comprising input devices such as a keyboard and mouse whereby the user inputs operating commands, an output section 1007 that outputs images of the processing operation screen and operation result to the display device, a storage section 1008 comprising a hard disk drive or the like for storing programs and a variety of data, and a communication section 1009 that executes communication processing via a network represented by the Internet comprising a LAN (Local Area Network) adapter or the like. In addition, a drive 1010 which reads and writes data to removable media 1011 such as magnetic disks (including flexible disks), optical disks (including CD-ROM (Compact Disc-Read Only Memory), DVD (Digital Versatile Disc), magneto-optical disks (including MD (Mini Disc)), or semiconductor memory is connected.

The CPU 1001 executes various processing in accordance with programs stored in the ROM 1002 or programs which are installed in the storage section 1008 after being read from the removable media 1011 such as magnetic disks, optical disks, magneto-optical disks, or semiconductor memory and which are loaded from the storage section 1008 into the RAM 1003. Data required by the CPU 1001 to execute various processing is also suitably stored in the RAM 1003.

In this specification, the steps describing the programs recorded on the recording media include processing that is executed chronologically in the mentioned sequence and, naturally, processing that is not necessarily executed chronologically which is executed in parallel or individually.

Furthermore, in the above specification, the system represents all devices constituted by a plurality of devices.

What is claimed is:

1. A monitoring device, comprising:
accumulation means for accumulating facial images of registered people that have been pre-registered;
image pickup means for picking up an image;
facial image extraction means for extracting a facial image of a checking target person from the image picked up by the image pickup means;
judgment means for judging whether the facial image has been acquired under predetermined conditions from the image by the facial image extraction means;
control means for controlling the image pickup state of the image pickup means when the facial image has not been acquired under predetermined conditions from the image by the facial image extraction means according to the judgment result of the judgment means;
checking means for calculating and checking the similarity between the facial image of a checking target person extracted by the facial image extraction means and the facial images of the registered people that have accumulated in the accumulation means;
similarity judgment means for judging whether the facial image of the checking target person is the facial image of a registered person through a comparison between the similarity, which is the checking result of the checking means, and a predetermined threshold value; and
communication means for communicating the fact that the checking target person is the registered person when it is judged by the similarity judgment means that the checking target person is the registered person.

2. The monitoring device according to claim 1, further comprising:
facial feature extraction means for extracting feature from the facial image of the checking target person, wherein the checking means calculates similarity by using the feature of the facial image of the checking target person acquired by the acquisition means and facial images of registered people that have accumulated in the accumulation means and checks the facial image of the checking target person acquired by the acquisition means against the facial images of the registered people that have accumulated in the accumulation means.

3. The monitoring device according to claim 1, further comprising:
unregistered person registration means for registering a facial image of the checking target person as an unregistered person when it is judged by the similarity judgment means that the checking target person is not the registered person.

4. The monitoring device according to claim 3, wherein the accumulation means accumulate facial images, of registered people that have been pre-registered, in the form of a data base; and
facial images of unregistered people that have been registered a predetermined number of times or more by the unregistered person registration means are registered in the database as the facial images of the registered people.

5. The monitoring device according to claim 1, wherein the control means comprise:
focus control means for controlling the focal position of the image pickup means;
pan-tilt-zoom control means for controlling at least any of the pan, tilt, and zoom positions of the image pickup means; and
iris control means for controlling the iris of the image pickup means,
wherein, in cases where, in accordance with the judgment result of the judgment means, a facial image cannot be extracted from the image by the facial image extraction means, the focus control means controls the focal position of the image pickup means and the pan-tilt-zoom control means adjusts the image pickup state of the image pickup means by controlling at least any of the pan, tilt, and zoom positions of the image pickup means; and
in cases where, in accordance with the judgment result of the judgment means, a facial image has been extracted from the image by the facial image extraction means and the difference in brightness of the facial image from that of a predetermined facial image is larger than a predetermined threshold value, the iris control means adjusts the image pickup state of the image pickup means by controlling the iris of the image pickup means.

6. The monitoring device according to claim 5, wherein, in cases where a facial image cannot be extracted from the image by the facial image extraction means, the focus control means controls the focal position of the image pickup means and the pan-tilt-zoom control means adjusts the image pickup state of the image pickup means so that the focal point is moved further away in steps at predetermined distance intervals by controlling at least any of the pan, tilt, and zoom positions of the image pickup means.

7. The monitoring device according to claim 6, further comprising:
recording means for recording an image that is picked up by the image pickup means,
wherein defective detection information is generated on the basis of the images recorded by the recording means, in cases where a facial image cannot be extracted from the image by the facial image extraction means in a state where the image pickup state of the image pickup means is adjusted by moving the focal position a predetermined distance away as a result of the focus control means controlling the focal position of the image pickup means and the pan-tilt-zoom control means controlling at least any of the pan, tilt, and zoom positions of the image pickup means.

8. The monitoring device according to claim 1, further comprising:
passage sensing means for sensing the passage of the checking target person,
wherein the judgment means judges whether a facial image can be acquired under predetermined conditions from the image by the facial image extraction means trough a comparison between the ratio of the frequency of extraction of a facial image from the image by the facial image extraction means with respect to the sensing frequency of the passage sensing means, and a predetermined value and, when the ratio is smaller than the predetermined value, the judgment means judges that a facial image cannot be acquired from the image by the facial image extraction means under predetermined conditions.

9. A monitoring method, comprising:
an accumulation step of accumulating facial images of registered people that have been pre-registered;
an image pickup step of picking up images;
a facial image extraction step of extracting the facial image of a checking target person from the image picked up by the processing of the image pickup step;
a judgment step of judging whether a facial image can be extracted under predetermined conditions from the image by the processing of the facial image extraction step;
a control step of controlling the image pickup state of the processing of the image pickup step in cases where a facial image cannot be extracted under predetermined conditions from the image by the processing of the facial image extraction step in accordance with the judgment result of the processing of the judgment step;
a checking step of calculating and checking the similarity between the facial image of the checking target person extracted by the processing of the facial image extraction step and the facial images of the registered people that have accumulated in the accumulation step;
a similarity judgment step of judging whether the facial image of the checking target person is the facial image of a registered person through a comparison between the similarity which is the checking result of the processing of the checking step and a predetermined threshold value; and
a communication step of communicating the fact that the checking target person is the registered person in cases where it has been judged, by the processing of the similarity judgment step, that the checking target person is the registered person.

10. A program that causes a computer to execute processing, comprising:
an accumulation step of accumulating facial images of registered people that have been pre-registered;
an image pickup step of picking up an image;
a facial image extraction step of extracting a facial image of a checking target person from the image that has been picked up by the processing of the image pickup step;
a judgment step of judging whether the facial image has been extracted under predetermined conditions from the image by the processing of the facial image extraction step;
a control step of controlling the image pickup state of the processing of the image pickup step when the facial image has not been extracted under predetermined conditions from the image by the processing of the facial image extraction step according to the judgment result of the processing of the judgment step;
a checking step of calculating and checking the similarity between the facial image of a checking target person extracted by the processing of the facial image extraction step and the facial images of the registered people that have accumulated in the accumulation step;
a similarity judgment step of judging whether the facial image of the checking target person is the facial image of a registered person through a comparison between the similarity, which is the checking result of the checking step, and a predetermined threshold value; and
a communication step of communicating the fact that the checking target person is the registered person when it is judged by the processing of the similarity judgment step that the checking target person is the registered person.
